(19) United States
(12) Patent Application Publication
(10) Pub. No.: US 2026/0156167 A1
(43) Pub. Date: Jun. 4, 2026

(54) METHOD AND SYSTEM OF GENERATING A SIGNAL FOR VIDEO COMMUNICATION

(71) Applicant: BARCO N.V., Kortrijk (BE)

(72) Inventors: Donny TYTGAT, Kortrijk (BE); Rajeev SHAIK, Kortrijk (BE); Erwin SIX, Kortrijk (BE)

(73) Assignee: BARCO N.V., Kortrijk (BE)

(21) Appl. No.: 19/121,898

(22) PCT Filed: Oct. 18, 2023
(86) PCT No.: PCT/EP2023/079072

§ 371 Date: Apr. 17, 2025

(30) Foreign Application Priority Data
Oct. 18, 2022 (LU) LU502918

(51) Int. Cl. H04L 65/403; G06V 20/40; G06V 20/52; G06V 40/18

(52) U.S. Cl. CPC H04L 65/403; G06V 20/41; G06V 20/52; G06V 40/18; G06V 2201/10

(57) ABSTRACT

Method of generating a signal associated with a participant of video communication including providing at least two sensors in a meeting location for acquiring a respective sensor signal; providing a host processing device for each of the at least two sensors for receiving and analysing the respective sensor signal for generating respective metadata; each host processing device sending the respective metadata to a client processing device; the client processing device determining whether to request at least a part of the respective sensor signal acquired by at least one of the at least two sensors; upon determining to request the respective sensor signal, the client processing device sending a request to the host processing device receiving the respective sensor signal; upon receiving the request, the host processing device sending the sensor signal to the client processing device; the client processing device generating the signal associated with the participant for video communication.

### TECHNICAL FIELD

The present document relates to a method and a system of generating a signal associated with a participant of video communication. Particularly, the present document relates to a method and a system of generating a signal associated with a participant of video conference.

### BACKGROUND

Video communication, especially video conference, is known to be a form of multipoint reception and transmission of signals by participants in different locations. A plurality of participant in several different locations all can be viewed by every participant at each location.

Hybrid conferences have been widely used nowadays as they are not only cost effective, but can mitigate the constraints of travel, time zone, etc. In a typical hybrid conference, some participants may attend the conference physically in the meeting room, while others may attend virtually by reception and transmission of signals from and to other participants.

Each of the participants may have an individual device, such as a laptop or a smartphone comprising a camera, a microphone, a loudspeaker, and a display, for participating in the video communication. Some of the participants in a same meeting location, e.g., a meeting room, may participate in the video communication by sharing a video conference system provided in the meeting location. Such a video conference system typically comprises a central control unit connecting to a camera, a microphone, a loudspeaker, and a display, etc. The video conference system camera is typically provided in one end of the meeting room for providing a good overview of the meeting room and the participants physically in the meeting room.

The advanced video conference system can provide additionally functionalities by integrating different technologies. For example, by using virtual director techniques, a speaker in the meeting room can be automatically detected, and the video conference system camera can zoom in to focus on that speaker, such that the remote participant can have a closer and better view of the speaker.

However, since different vendors of video conference systems normally have different solutions to improve the video conference functionalities, the user experiences of a remote participant would largely depend on the video conference system used for the video conference, which can hardly be consistent. Normally, the video conference system would only provide a limited possibility for the participants to adjust the audio and video signals of the video communication, e.g., replacing a background, muting a microphone, etc. Further, for a large meeting room, the video conference system camera cannot provide a clear view for every participant in the meeting room, as the video conference system camera may be fixed on a location having a long distance away from some of the participants in the meeting room. Multiple video conference system cameras may be installed in different locations within such large meeting rooms to solve the problem.

Alternatively, the video conference system camera may be upgraded to meet the requirement of the video communication.

Moreover, it may also be difficult to show a frontal view of every participant in the meeting room. For example, if one participant in the meeting room is often engaged with his laptop, it is difficult for the video conference system camera to capture a frontal view of this particular participant.

Thus, there is a need to provide an improved method and system of generating a signal associated with a participant of video communication.

### SUMMARY

It is an object of the present disclosure, to provide an improved method and system of generating a signal associated with a participant of video communication, which eliminates or alleviates at least some of the disadvantages of the prior art.

The invention is defined by the appended independent claims. Embodiments are set forth in the appended dependent claims, and in the following description and drawings.

According to a first aspect, there is provided a method of generating a signal associated with a participant of video communication. The method comprises: providing at least two sensors in a meeting location, each sensor acquiring a respective sensor signal, wherein at least one of the acquired sensor signals comprises information related to the participant; providing a host processing device for each of the at least two sensors for receiving and analysing the respective sensor signal for generating respective metadata, wherein the respective metadata comprises information about the respective sensor signal; each host processing device sending the respective metadata to a client processing device; the client processing device determining, based on the received respective metadata, whether to request at least a part of the respective sensor signal acquired by at least one of the at least two sensors; upon determining to request the at least a part of the respective sensor signal, the client processing device sending a request to the host processing device receiving the respective sensor signal from the at least one of the at least two sensors; upon receiving the request, said host processing device sending the at least a part of the respective sensor signal to the client processing device; the client processing device generating the signal associated with the participant for video communication based on the received at least a part of the respective sensor signal.

In the prior art, the video communication typically relies on a local/remote central unit for receiving the captured signals, e.g., video signals, of each participant, and generating a signal representing each participant such that all the participants in several different locations can be viewed by every participant at each location. The central unit has to receive and process all the signals from different participants. Thus, the central unit at least needs to have a large storage and a fast processor to store and process the signals.

The inventive concept of the invention is to generate a signal associated with a participant of video communication by using one or more available devices, without any central control unit for controlling or mediating these devices. The devices may be any devices of the participants, such as a personal computer, a laptop, a smartphone, a video conference system, a base unit, a server, and any other devices present in the meeting space. By using multiple existing devices for generating the signal associated with the participant, instead of any central control unit, the video conference can be performed at a lower cost, as there is no need to upgrade the existing video conference system for a better capacity.

The term “video communication” in the application may refer to any forms of technology mediated communication, irrespective video is involved or not. Examples of technology mediated communication may include texting, videoconferencing, social networking, and messenger Apps, etc.

Further, since only a part of the acquired signals, which is of interest, needs to be sent and received between the devices, less data transmission is needed, which can mitigate the bandwidth requirement of data transmission between the devices and the processing capability requirement of the device for processing the signals.

Moreover, the possibility of using signals acquired by different sensors, e.g., cameras, may provide additional information to the remote participants, whom can have a better video conference experience.

The sensor may be a device for producing an output signal by sensing a physical phenomenon. For example, the sensor may comprise an imaging device for detecting and conveying information for generating an image or a video. The sensor may comprise e.g., a visual sensor or a virtual camera for obtaining an image/video signal, an audio sensor for obtaining an audio signal, and an input port for receiving a sensor signal.

For example, the sensor may be an integral camera of a computing device, such as a personal computer, a laptop, a smartphone, a camera of a video conference system, such as a room camera focusing on a podium of the video conference room.

The sensor may be a virtual sensor, wherein its exposed sensor data is sourced from a digital signal, e.g., a virtual content such as a presentation, a shared content, an image, a video file, a video stream, an audio file, an audio stream, a 3D model, a 3D video stream, a volumetric stream, a digital twin, and a data stream.

The sensor may be a virtual sensor. The sensor data that is exposed by a virtual sensor may be generated by a model. Said model may be using an input of another real-or virtual sensor. Said model may be a parameterizable 3D model, a generative Al model, a neural network or any other model that may generate a signal that can be exposed by a virtual sensor. The generation of the signal associated with the participant of video communication may include, in part or as a whole, a signal generated by a model. Said model may be using at least part of a sensor signal as an input. Said model may be using other input sources. Said model may be a parameterizable 3D model, a generative Al model, a neural network or any other model that may generate a signal that can be, in part or as a whole, included in the generated signal associated with the participant of video communication.

Since the at least two sensors are provided in the meeting location, the sensed signals of the two sensors may be different and can be used to supplement each other for providing more information about the participant. The respective sensor signal acquired by the sensors may comprise information related to the same or different participant(s) in the meeting location.

The sensor signal in the application may comprise a video signal and/or an audio signal. The sensor signal may comprise any other types of signal, e.g., a depth signal related to a participant acquired by a depth sensor.

The information related to a participant may refer to that the information directly or indirectly related to said participant. In other words, said information doesn't need to directly relate to the participant himself. For example, one participant being a person is in a meeting room, and when another person or another entity in the same meeting room changes their status, information representing the another person/entity and/or the changes of the another person/entity are also related to the person, although said information is only indirectly related to the person. In other words, information related to other participants or entities involving in the video communication may also be considered to be related to said participant.

The sensor signals comprising information related to the participant may be acquired by any provided sensors, not necessarily to be a sensor associated to the participant, e.g., the participant's laptop camera. For example, the camera of the participant's laptop may acquire video signals of said participant for video communication. When the participant is away from his laptop, the room camera may provide a better view of the participant than his laptop camera.

A same or two different devices may be the host and client processing device. For example, a smartphone (e.g., its processing unit) of a participant may be both the host and client processing device. For example, a central control unit of the video conference system (e.g., its processing unit) may be the host processing device, and a laptop (e.g., its processing unit) of a participant may be the client processing device.

In other words, the method can be performed in a distributed way such that multiple devices may be involved for generating the signal associated with a participant of video communication, instead of using a centralised system. The sensor, the host processing device, and the client processing device may be a same or different device(s). For example, the sensor is not necessarily co-located with the host processing device, and the use of the sensor signal is not limited to the sensor itself.

The metadata may comprise a property of the respective sensor signal, such as information of resolution, and information of framerate of the respective sensor signal.

The metadata may comprise information of detection of one or more events in the sensor signal, such as detection of a person, detection of a speaker, detection of a gesture or movement of a person, identification of a person, identification of a speaker, identification of a gesture or movement of a person, identification of a position of a person relative to an entity (such as a white board and/or a podium), absence of a person, estimated capture quality of a person, spatial information of a detected person in camera space or in world space, and recognition of an audio signature of a person.

The gesture or movement of a person may comprise: a movement of a lip, raising a hand, standing up, shaking heads, etc.

The metadata may comprise information of detection of one or more events in the sensor signal, such as detection of an entity (non-human object, such as a furniture and a collaboration equipment), identification of an entity, detection of a change of an entity (such as a movement), absence of an entity, estimated capture quality of an entity, spatial information of a detected entity in camera space or in world space, and identification of a visual fingerprint of an entity.

The metadata may comprise information of detection of one or more events in the sensor signal, such as an overall audio level, and detection of an audio signature of a specific event, etc.

The metadata may comprise information representing a singular event. The singular event may comprise a recognisable action or occurrence, such as identification of a person entering a frame.

The metadata may comprise information representing an event being continuous in nature, e.g., a framerate of the video signal, detection of presence of a person, detection of a person located at a bounding box in the frame, etc.

The transmission of the metadata, the request, and the at least a part of the respective video signal may be conducted in a same or different way(s), such as via a data bus, or wirelessly.

The transmission of the metadata, the request, and the at least a part of the respective video signal may be conducted by a same or different communication protocols, such as Wi-Fi, and Bluetooth.

In general, the communication protocols (or means of communication) can be any one of Wi-Fi, Bluetooth, Zigbee, RF, optical or InfraRed, such as IrDA, diffuse infra-red, WLAN, WiMax, LiFi, ultrasound, LoRa, NBIOT, or Thread or any other wireless communication network known to the person skilled in the art. Any communications protocols disclosed can be and preferably is wireless, but can also be wired communication. The participant of video communication may be a person or a non-human object involving in the video communication.

The participant may be one or more persons. The participant may actively, e.g., speakers, or passively, e.g., listeners, participating the video communication.

The participant may be one or more non-human objects, e.g., a robot, and a conference room, a device, involving in the video communication. For example, the conference room and/or a screen may be a participant being present in the video communication.

The signal associated with the participant for video communication may be playable by a device involving in the video communication. The device involving in the video communication may be a device associated with the same participant or a different participant of the video communication.

The signal associated with the participant may comprise video information associated with the participant, which video information is playable/displayable by a device, e.g., a display, associated with one or more participants.

The signal associated with the participant may comprise audio information associated with the participant, which audio information is playable by a device, e.g., a loudspeaker, associated with one or more participants.

The signal may comprise any of: a video image, a video clip, and a video stream.

There may be one or more signals associated with the participant for a single participant being generated. For example, multiple signals may be generated for multiple remote participants (or remote participant groups). For example, multiple signals may be generated for a meeting room to provide different views of the meeting room. One signal associated with the meeting room may be generated with a focus on the context/overview of the meeting room, while another signal associated with the meeting room may be generated with a focus on the persons having conversations in the meeting room.

The method may further comprise:
the client processing device sending the generated signal associated with the participant to a video communication device for conducting video communication with a remote participant of video communication.

The term “remote participant” may refer to that the remote participant is physically separated in space from other participants, from the meeting location, and/or from the at least two sensors, such that the remote participant can only know what is happening with other participants within the meeting location through the generated signal associated with the participants.

The video communication device may be a device running a video communication software.

The video communication device may be a virtual reality platform, an augmented reality platform, or a mixed reality platform.

The video communication device may be a server, e.g., of a video communication service provider. The video communication service provider may be a Unified Communications and Collaboration, UC&C, service provider. Examples of UC&C service include: Teams, Zoom, Skype, etc.

The video communication device may provide function of a UC&C client.

The video communication device may be a virtual camera. The generated signal associated with the participant for video communication may be exposed to a UC&C client via the virtual camera.

The step of the client processing device determining, based on the received respective metadata, whether to request at least a part of the respective sensor signal acquired by at least one of the at least two sensors may comprise:
the client processing device determining based on the received respective metadata and a strategy of generating the signal associated with the participant for video communication.

The strategy of generating the signal associated with the participant for video communication may comprise one or more rules for facilitating the generation of an improved signal associated with the participant for video communication. For example, the strategy may indicate how the signal associated with the participant for video communication should be generated by taking into account perceptual models (i.e. what should the signal be constructed by in order to optimally convey certain information to the users (e.g., a remote participant) of the signal.

The strategy may comprise to generate the signal associated with the participant for video communication based on a list of metadata comprising information about different sensor signals, in a certain order. If the respective metadata is the same as any metadata of the list of metadata, it is determined to request the at least a part of the respective sensor signal. If the metadata is not the same as any of the list of metadata, no request is sent.

For example, if the sensor signal and its metadata comprise information of a participant raising a hand, and one metadata of the list of metadata is about a person raising a hand, it is determined to request the at least a part of the respective sensor signal. For example, if the respective metadata indicating a high resolution of the sensor signal and one metadata of the list of metadata is about the high resolution of the sensor signal, it is determined to request the at least a part of the respective sensor signal.

The strategy may be predetermined. The strategy may be created and/or changed. The strategy may be predetermined based on the settings and requirements of the video communication, e.g., the bandwidth of the video communication, the number of participants, etc.

The strategy may be created and/or changed, by a participant and/or a device involving in the video communication.

The step of the client processing device generating the signal associated with the participant for video communication may comprise:
the client processing device generating said signal based on the received at least a part of the respective sensor signal acquired by more than one sensor.

The step of the client processing device generating the signal associated with the participant for video communication may comprise:
the client processing device generating said signal based on the received at least a part of the respective sensor signal acquired by each of the at least two sensors.

Comparing with a sensor signal acquired by a single sensor, the signal generated by the invention may improve remote participant meeting experiences by providing information acquired by different sensors interested to the remote participant. This may provide additional contextual information of what is happening in the meeting location to the remote participant, which can provide a more “on-site” meeting experience.

The step of the client processing device generating the signal associated with the participant for video communication based on the received at least a part of the respective sensor signal may comprise:
the client processing device generating the signal by any of: temporal multiplexing, spatial multiplexing, and multi-modal aggregation.

The generated signal associated with the participant may be composed of a part of the respective video signal acquired by one or more of the at least two sensors.

The step of each host processing device sending the respective metadata to a client processing device may comprise:
sending the respective metadata by using a centralised node for receiving the respective metadata from the host processing device, and forwarding to the client processing device.

The step of each host processing device sending the respective metadata to a client processing device may comprise:
sending the respective metadata by a wireless connection or a wired connection between each host processing device and the client processing device.

The step of each host processing device sending the respective metadata to a client processing device may comprise:
sending the respective metadata by using a metadata exchange service.

The centralised node may be a network node which can receive, store and send data. An example of the centralised node may be a central control unit of a video conference system.

The step of sending the respective metadata by a wireless connection or a wired connection may comprise: sending the respective metadata by a broadcasting network.

The step of sending the respective metadata by a wireless connection or a wired connection may comprise: sending the respective metadata by a point-to-point network.

Both the broadcasting and the point-to-point network may be either a wired or a wireless network.

The point-to-point wireless network may be an ad-hoc network. Wi-Fi, Bluetooth interfaces may be used for achieving the point-to-point wireless communication.

The step of sending the respective metadata by using a metadata exchange service may comprise:
the metadata exchange service receiving the respective metadata from each host processing device, and forwarding to the client processing device.

The method may comprise: the metadata exchange service storing the respective metadata.

The method may comprise: the metadata exchange service storing and/or updating a state of the respective metadata.

The method may comprise: the metadata exchange service filtering the respective metadata.

The metadata exchange service may be a cloud based service.

Besides simply forwarding the generated metadata, the metadata exchange service can have additional functions.

The metadata exchange service may store the metadata and optionally aggregate the received metadata into a consistent state. The metadata exchange service may expose the stored/aggregated metadata to the client processing device, e.g., in an asynchronous manner.

For example, the metadata exchange service may hold and store a state of the metadata such that it can be retrieved later, e.g., by the host processing device and/or the client processing device. The metadata exchange service may update the state of the metadata. The state of the metadata may be queried, e.g., by the host processing device and/or the client processing device, in an asynchronous manner.

For example, the metadata exchange service may have a query-based filtering mechanism, e.g., via graphql. For example, the metadata exchange service may have a pub-sub functionality, intelligently merge/process metadata, e.g., relating a part of a first metadata relating to identification of a person of a first sensor signal acquired by a first sensor to a part of a second metadata relating to identification of the same person of a second sensor signal acquired by a second sensor.

Either the sender or the receiver of metadata using the metadata exchange service may filter the metadata, e.g., for finding out which metadata is of interest. For example, the host processing device may filter the metadata for only sending the metadata of interest. The client processing device may indicate which metadata it is interest to receive. This may reduce the number of metadata transferred between the host and client processing device. This may reduce the bandwidth required for sending and receiving metadata.

The step of said host processing device sending the at least a part of the respective sensor signal to the client processing device may comprise:
sending said at least a part of the respective sensor signal by using a centralised node for receiving said at least a part of the respective video signal from said host processing device, and forwarding to the client processing device.

The step of said host processing device sending the at least a part of the respective sensor signal to the client processing device may comprise:
sending said at least a part of the respective sensor signal by a wireless connection or a wired connection between said host processing device and the client processing device. The transmission of the at least a part of the respective sensor signal may be performed by one or more different ways, such as via a wire, or wirelessly.

The transmission of the at least a part of the respective sensor signal may be performed under one or more different communication protocols, such as Wi-Fi, and Bluetooth.

The transmission of the request may be performed analogously as the transmission of the at least a part of the respective sensor signal.

The step of sending said at least a part of the respective sensor signal by a wireless connection or a wired connection may comprise:
sending said at least a part of the respective sensor signal by a broadcasting network.

The step of sending said at least a part of the respective sensor signal by a wireless connection or a wired connection may comprise:
sending said at least a part of the respective sensor signal by a point-to-point network.

The step of providing a host processing device for each of the at least two sensors may comprise:
providing one host processing device for each of the at least two sensors such that each of the at least two sensors has an individual host processing device.

The step of providing a host processing device for each of the at least two sensors may comprise:
providing at least one host processing device for the at least two sensors, such that at least one sensor of the at least two sensors shares a same host processing device with another sensor of the at least two sensors.

One sensor may be provided with an individual host processing device.

Alternatively, one sensor may share the same individual host processing device with another or other sensor(s).

The host processing device may comprise:
a router function module for receiving the respective sensor signal, receiving the request from the client processing device, and sending the at least a part of the respective sensor signal to the client processing device upon receiving the request;
an analysis function module for analysing the respective sensor signal for generating the respective metadata; and
a metadata router function module for sending the generated metadata to the client processing device.

The client processing device may comprise:
a metadata receiver function module for receiving metadata from the host processing device;
a determination function module for determining, based on the received respective metadata, whether to request at least a part of the respective sensor signal;
a transceiver function module for sending the request to the host processing device, and receiving the at least a part of the respective video signal from the host processing device; and
a composing function module for generating the signal associated with the participant for video communication.

The client processing device may comprise a device body. At least one of the at least two sensors may be attached to said device body.

The host processing device may comprise a device body. At least one of the at least two sensors may be attached to said device body.

A same device (e.g., a laptop) may comprise at least one of the sensors and act as the client processing device. The sensor may be an integral part of the same device or an external sensor operatively connected to the same device, e.g., by a USB cable. For example, the sensor may be a laptop camera, or an auxiliary camera operatively connected to the laptop by a USB cable, and the processing unit of the same laptop may perform functions of the client processing device. Thus, the client processing device may receive sensor signals from its own laptop camera or from the connected auxiliary camera.

Alternatively, or in combination, one device (e.g., a first laptop) may comprise the sensor and another device (e.g., a second laptop) may be the client processing device.

Analogously, a same device may comprise at least one of the sensors and act as the host processing device. Alternatively, or in combination, one device (e.g., a first laptop) may comprise the sensor and another device (e.g., a second laptop) may be the host processing device.

The signal associated with the participant of video communication may be a video signal.

The video signal may comprise any of: a video image, a video clip, and a video stream.

According to a second aspect, there is provided a system of generating a signal associated with a participant of video communication. The system comprises at least two sensors provided in a meeting location, each sensor being configured to acquire a respective sensor signal, wherein at least one of the acquired sensor signals comprises information related to the participant. The system comprises a host processing device provided for each of the at least two sensors, wherein each host processing device is configured to receive and analyse the respective sensor signal for generating respective metadata comprising information about the respective sensor signal, wherein each host processing device is configured to send the respective metadata to a client processing device. The system comprises the client processing device configured to: determine, based on the received respective metadata, whether to request at least a part of the respective sensor signal acquired by at least one of the at least two sensors, upon determining to request the at least a part of the respective sensor signal, send a request to the host processing device receiving the respective sensor signal from the at least one of the at least two sensors. Said host processing device is configured to, upon receiving the request, send the at least a part of the respective sensor signal to the client processing device. The client processing device is configured to generate the signal associated with the participant for video communication based on the received at least a part of the respective sensor signal.

The features of the first aspect are analogously applicable to the second aspect.

The participant of video communication may be a person or a non-human object involving in the video communication.

The signal associated with the participant for video communication may be playable by a device involving in the video communication.

The client processing device may be configured to send the generated signal associated with the participant to a video communication device for conducting video communication with a remote participant of video communication.

The client processing device may be configured to determine based on the received respective metadata and a strategy of generating the signal associated with the participant for video communication.

The strategy may be predetermined.

The strategy may be created.

The strategy may be changed.

The client processing device may be configured to generate said signal based on the received at least a part of the respective sensor signal acquired by more than one sensor.

The client processing device may be configured to generate said signal based on the received at least a part of the respective sensor signal acquired by each of the at least two sensors.

The client processing device may be configured to generate the signal by any of:
temporal multiplexing, spatial multiplexing, and multi-modal aggregation.

The host processing device may be configured to send the respective metadata by using a centralised node for receiving the respective metadata from the host processing device, and forwarding to the client processing device.

The host processing device may be configured to send the respective metadata by a wireless connection or a wired connection between each host processing device and the client processing device.

The host processing device may be configured to send the respective metadata by using a metadata exchange service.

The host processing device may be configured to send the respective metadata by a broadcasting network.

The host processing device may be configured to send the respective metadata by a point-to-point network.

The metadata exchange service may be configured to receive the respective metadata from each host processing device, and forward to the client processing device.

The metadata exchange service may be configured to store the respective metadata.

The metadata exchange service may be configured to store and/or update a state of the respective metadata.

The metadata exchange service may be configured to filter the respective metadata.

The host processing device may be configured to send said at least a part of the respective sensor signal by using a centralised node for receiving said at least a part of the respective video signal from said host processing device and forwarding to the client processing device.

The host processing device may be configured to send said at least a part of the respective sensor signal by a wireless connection or a wired connection between said host processing device and the client processing device.

The host processing device may be configured to send said at least a part of the respective sensor signal by a broadcasting network.

The host processing device may be configured to send said at least a part of the respective sensor signal by a point-to-point network.

The system may comprise one host processing device for each of the at least two sensors such that each of the at least two sensors may have an individual host processing device.

The system may comprise at least one host processing device for the at least two sensors, such that at least one sensor of the at least two sensors may share a same host processing device with another sensor of the at least two sensors.

The host processing device may comprise a router function module configured to receive the respective sensor signal, receive the request from the client processing device, and send the at least a part of the respective sensor signal to the client processing upon receiving the request.

The host processing device may comprise an analysis function module configured to analyse the respective sensor signal for generating the respective metadata.

The host processing device may comprise a metadata router function module configured to send the generated metadata to the client processing device.

The client processing device may comprise a metadata receiver function module configured to receive metadata from the host processing device.

The client processing device may comprise a determination function module configured to determine, based on the received respective metadata, whether to request at least a part of the respective sensor signal.

The client processing device may comprise a transceiver function module configured to send the request to the host processing device, and receive the at least a part of the respective video signal from the host processing device.

The client processing device may comprise a composing function module configured to generate the signal associated with the participant for video communication.

The client processing device may comprise a device body. At least one of the at least two sensors may be attached to the device body.

The host processing device may comprise a device body. At least one of the at least two sensors may be attached to the device body.

The signal associated with the participant of video communication may be a video signal.

There is also provided

A method of generating a signal associated with a participant of video communication, comprising:
providing a first sensor (1a) and a second sensor (1b,1c) in a meeting location, each sensor acquiring a respective sensor signal, wherein at least one of the acquired sensor signals comprises information related to the participant;
providing a first host processing device (2a) for the first sensor (1a) and a second host processing device (2b, 2c) for the second sensor (1b,1c) for receiving and analyzing the respective sensor signal for generating respective metadata, wherein the respective metadata comprises information about the respective sensor signal;
each host processing device (2a, 2b, 2c) sending the respective metadata to a client processing device (3a, 3b, 3c);
the client processing device (3a, 3b, 3c) generating the signal associated with the participant of video communication based on the received at least part of the respective sensor signal.

Preferably, the first sensor is a video camera device that is connected to or integrated in a video conference system in the meeting location and wherein the second sensor is a video camera device that is connected to or integrated in a user processing device in the meeting location.

Preferably, the second sensor is analyzed by the user processing device for generating respective metadata, wherein the respective metadata comprises information about the respective signal.

Preferably, the user processing device generates the signal associated with the participant of video communication based on the said respective metadata.

Preferably, the signal associated with a participant of video communication that is generated by the user processing device is made available to a video communication client that is running on the user processing device.

Preferably, a peripheral device that is coupled to said user processing device exposes the generated signal associated with the participant of video communication to said user processing device.

Preferably, the metadata comprises information on the viewing direction of at least one user in said meeting location.

Preferably, the metadata of the second sensor comprises information on the viewing direction of the user of said user processing device relative to said second sensor.

Preferably, said generated signal is primarily based on at least part of the second sensor when the metadata indicates that said user of said user processing device is looking in the direction of said second sensor and wherein said generated signal is bit primarily based on at least part of the second sensor when the metadata indicates that said user of said user processing device is not looking in the direction of said second sensor.

Preferably, said client processing device (3a, 3b, 3c) determines, based on the received metadata, whether to request at least a part of the sensor signal acquired by at least one of the two sensors;

upon determining to request the at least a part of the respective sensor signal, the client processing device (3a, 3b, 3c) sending a request to the host processing device receiving the respective sensor signal from the at least one of the two sensors.

Preferably, said host processing device (2a, 2b, 2c), after receiving said request, sending the at least a part of the respective sensor signal to the client processing device.

Preferably, it is determined to request at least a part of the second sensor signal based on the information of the viewing direction of the user of the user processing device relative to the second sensor when the information indicates that the user is looking towards said second sensor.

Preferably, it is determined to request at least a part of the first sensor signal based on the information of the viewing direction of the user of the user processing device relative to the second sensor when the information indicates that the user is looking away from said second sensor.

Preferably, the determination of the indication that the user is looking at or away from the user processing device is based on a predetermined threshold.

Preferably, the at least part of the respective sensor signal represents a transformed version of the respective sensor signal.

Preferably, the at least part of the respective sensor signal represents a synthesized signal that is the output of a model that uses at least part of the respective sensor signal at the input.

Preferably, the metadata comprises information on the voice activity of a user in said meeting location.

Preferably, generating the signal associated with the participant of video communication comprises
a. a determination of relevance of a sensor signal relative to another sensor signal;
b. a determination of composition based at least on the relevance of a sensor signal relative to another sensor signal;
c. a generation of the signal associated with the participant of video communication based on the determined composition.

Preferably, the relevance of a sensor signal relative to another sensor signal is determined based on the viewing direction of the user of the processing device Preferably, the relevance of a sensor signal relative to another sensor signal is determined based on the voice activity of the user of the processing device.

Preferably, the composition temporally switches between the at least part of a first sensor signal and the at least part of a second sensor signal based on the determined relevance of each of the signals.

Preferably, the composition applies a transform to the at least part of a first sensor signal and the at least part of a second sensor signal based on the determined relevance of each of the signals and spatially or temporally combines the respective transformed signals.

In addition, there is also provided
1. A method of generating a signal associated with a participant of video communication, comprising:
   providing at least a first sensor and a second sensor in a meeting location, each sensor acquiring a respective sensor signal, wherein at least one of the acquired sensor signals comprises information related to the participant;
   analyzing at least one of the first or second sensor signal for generating respective metadata, wherein the respective metadata comprises information about the respective sensor signal;
   generating the signal associated with the participant of video communication based on the at least part of the first sensor signal and on the at least part of the second sensor signal and the respective metadata.
      Preferably, a first sensor is connected to or integrated in a video conference system in the meeting location and a second sensor is connected to or integrated in a user processing device in the meeting location.
      Preferably, the signal associated with the participant of video communication is generated by a user processing device in the meeting location.
      Preferably, the user processing device is adapted to access a unified communication between two or more processing devices.
      Preferably, the generated signal associated with a participant of video communication is communicated to the unified communication.
      Preferably, the video conference system in the meeting location consists at least out of a base unit to which the first sensor is connected to or integrated in.
      Preferably, the user processing device is wirelessly or wired connected to the video conference system, facilitating transmission of the at least part of the first sensor signal and respective metadata of the analyzed second sensor signal.
      Preferably, a peripheral device is coupled to the user processing device in the meeting location and wherein the peripheral device is wirelessly or wired connected to the video conference system in the meeting location, facilitating transmission of the at least part of the first sensor signal and respective metadata of the analyzed second sensor signal independent of the networking capabilities of the user processing device.
      Preferably, the peripheral device makes available the signal associated with the participant of the video communication to the user processing device.
      Preferably, the respective metadata comprises information on the viewing direction of a user in the meeting location.
      Preferably, the respective metadata comprises information on the voice activity of a user of the user processing device.
      Preferably, generating the signal associated with the participant of video communication comprises
   a determination of relevance of a sensor signal relative to another sensor signal;
   a determination of composition based at least on the relevance of a sensor signal relative to another sensor signal;
   a generation of the signal associated with the participant of video communication based on the determined composition.
      Preferably, the relevance of a sensor signal relative to another sensor signal is determined based on the viewing direction of the user of the processing device.
      Preferably, the relevance of a sensor signal relative to another sensor signal is determined based on the voice activity of the user of the processing device.
      Preferably, the composition temporally switches between the at least part of a first sensor signal and the at least part of a second sensor signal based on the determined relevance of each of the signals.
      Preferably, the composition applies a transform to the at least part of first sensor signal and the at least part of the second sensor signal based on the determined relevance of each of the signals and spatially or temporally combines the respective transformed signals.

Preferably, a first host processing device for the first sensor and a second host processing device for the second sensor is provided for receiving and analyzing the respective sensor signal for generating respective metadata, wherein the respective metadata comprises information about the respective sensor signal;
each host processing device sending the respective metadata to a client processing device;
providing a client processing device generating the signal associated with the participant of video communication based on the received at least part of the respective sensor signal.
   Preferably, the client processing device determines, based on the received respective metadata, whether to request at least a part of the respective sensor signal acquired by at least one of the two sensors;
upon determining to request the at least a part of the respective sensor signal, the client processing device (3a, 3b, 3c) sending a request to the host processing device receiving the respective sensor signal from the at least one of the two sensors;
after receiving the request, said host processing device (2a, 2b, 2c) determining to send the at least a part of the respective sensor signal to the client processing device;
upon determination sending the at least a part of the respective sensor signal to the client processing device.

Preferably, the host processing device, determines to send the at least a part of the respective sensor signal to the client processing device based on a determined priority for sending the at least a part of the respective sensor signal to the client processing device relative to sending the at least a part of the respective sensor signal to another client processing device.

Preferably, the host processing device sends the at least part of the respective sensor signal to a subset (one or more) of client processing devices with the highest relative priorities.

Preferably, the host processing device determines priority based on metadata information that the host processing device has available.

Preferably, the host processing device determines priority based on the viewing direction of the users in the meeting location in relation to at least one of the sensors in the meeting location.

Preferably, the host processing device determines priority based on metadata from at least user processing devices, the metadata comprising information of the viewing direction of the respective user of the user processing device relative to the respective sensor of the user processing device.

Preferably, the host processing device determines priority for sending the at least a part of the respective sensor signal to the client processing device based on predetermined rules. Preferably, the host processing device determines priority for sending the at least a part of the respective sensor signal based on a maximum duration that a client processing device can subsequently receive the at least a part of the respective sensor signal.

Preferably, the host processing device determines priority for sending the at least a part of the respective sensor signal based on any of a round-robin principle, a random selection, a weighted random sampling method.

Preferably, the at least part of the sensor signal represents a transformed version of the sensor signal.

Preferably, the at least part of the sensor signal represents a synthesized signal that is the output of a model that uses at least part of the sensor signal at the input.

Preferably, a host processing device for a respective sensor controls the respective sensor by
determining the control operations to be sent to the respective sensor to optimize the sensor signal;
sending control operations to the respective sensor; the host processing device receiving a optimized sensor signal from the respective sensor.

Preferably, the control operations are determined based on the received requests for at least part of the respective sensor signal.

Preferably, the control operations are determined based on metadata that was received from at least one client processing device or host processing device.

Preferably, the control operations are determined based on predetermined rules.

### BRIEF DESCRIPTION OF THE DRAWINGS

FIG. 1 is an example system of generating a signal associated with a participant of video communication.

FIG. 2a-2c are three example systems of generating a signal associated with a participant of video communication.

FIG. 3a-3b are two example systems of generating a signal associated with a participant of video communication.

FIG. 4a is an example of a video communication.

FIG. 4b-4c are examples of the sensor signals and the signals associated with participants of the video communication of FIG. 4a.

FIG. 5a is an example of a video communication.

FIG. 5b-5d are examples of the sensor signals and the signals associated with participants of the video communication of FIG. 5a.

FIG. 6 is an example of the method of generating a signal associated with a participant of video communication.

FIG. 7(a)-7(f) illustrate some examples of the physical devices which may be used.

### DESCRIPTION OF EMBODIMENTS

The present invention will now be described more fully hereinafter with reference to the accompanying drawings, in which currently preferred embodiments of the invention are shown.

Examples will be discussed herein to show how the invention can eliminate or alleviate at least some of the disadvantages of the prior art. Different features, configurations of these examples can be interchanged and combined. The arrangement of the devices in the examples only illustrate how the method/system of the invention can use the available devices in different ways. These examples should not be used to limit the claimed invention.

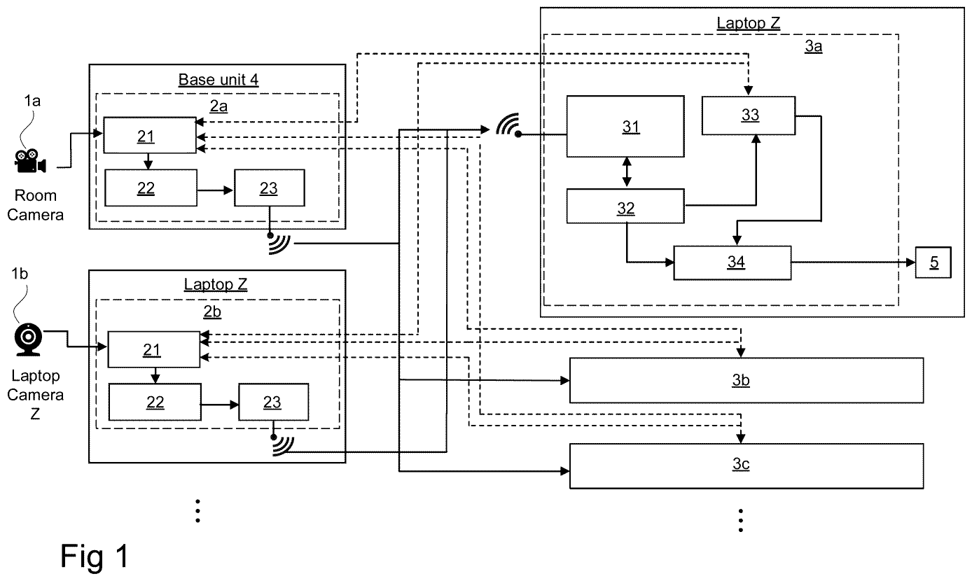

In connection with FIGS. 1-3b, examples of the system of generating a signal associated with a participant of video communication will be discussed in more detail.

In FIG. 1, two sensors 1a, 1b, are provided. In this example, a first sensor 1a is a video conference system camera (i.e. “room camera”) of an existing video conference system provided in a meeting location, e.g., a meeting room. A second sensor 1b is a camera of a laptop Z (i.e. “laptop camera Z”) in the meeting location. The sensor signals discussed herein may comprise a video signal and/or an audio signal.

The sensor may be a device for producing an output signal by sensing a physical phenomenon. For example, the sensor may comprise an imaging device for detecting and conveying information for generating an image or a video. The sensor may comprise, e.g., a visual sensor or a virtual camera for obtaining an image/video signal, an audio sensor for obtaining an audio signal, and an input port for receiving a sensor signal.

For example, the sensor may be an integral camera of a computing device, such as a personal computer, a laptop, a smartphone, a camera of a video conference system, such as a room camera focusing on a podium of the video conference room, a network camera, a wide angle camera (up to 360 degrees), a sensor of a head-mounted device (such as an AR/VR/MR headset), a sensor of a wearable device, a virtual sensor which can retrieve content from another source, an infrared sensor, an ultrasound sensor, and a microphone array.

Since at least two sensors are provided in the meeting location, the sensor signals acquired by the sensors may be different and can be used to supplement each other. The sensor signals acquired by the sensors may comprise information related to the same or different participant(s) in the meeting location.

Although the examples herein are the cameras and the video/audio signals, the invention may involve any other types of sensors and signals, e.g., a depth signal related to a participant acquired by a depth sensor.

Each of the two sensors 1a, 1b may acquire a respective sensor signal. At least one of the acquired sensor signals comprises information related to the participant. For example, at least one of the room camera 1a and the laptop camera 1b captures information related to the participant. The captured information related to the participant may be used to generate the signal associated with the participant of video communication. The sensor signals comprising information related to the participant may be acquired by any provided sensors, not necessarily to be a sensor associated to the participant, e.g., the participant's laptop camera. For example, the camera of the participant's laptop may acquire video signals of said participant for video communication. When the participant is away from his laptop, the room camera may provide a better view of the participant than his laptop camera.

In FIG. 1, multiple host processing devices and multiple client processing devices are provided, wherein two host processing devices 2a, 2b and three client processing devices 3a, 3b, 3c are discussed in more detail.

The host processing devices 2a, 2b are respectively provided for the sensors 1a, 1b. The host processing devices 2a, 2b can receive and analyse the respective sensor signal from the sensors 1a, 1b for generating respective metadata.

A host processing device may send control operations to a sensor. Said control operations may impact the signal that is received from said sensor. Said control operations may be used to adapt the signal coming from said sensor towards optimizing analysis and/or generating the signal associated with the participant of video communication. Said control operations may, for example, configure the sensor to output a cropped version of the camera data that shows a subset of people in the meeting location. Said control operations may, for example, configure the sensor to zoom into a certain person or multiple people computationally or mechanically. Said control operations may, for example, send a preference to see the person who is speaking. Said control operations may be determined based on requests for at least part of said sensor signal. Said control operations may be determined based on metadata. Said control operations may be determined based on pre-determined rules. Said control operations may be determined based on a context adaptive process.

The number of sensors, of host processing devices, and of client processing devices shown in the figures and discussed in the examples for illustrating the inventive concept of the invention are purely exemplary and should not be seen as limiting the invention in any means.

The host processing device 2a may send the metadata generated based on the sensor signal acquired by the room camera 1a to each of the client processing device 3a, 3b, 3c.

The host processing device 2b may send the metadata generated based on the laptop camera Z 1b only to the client processing device 3a. For example, the laptop Z may be both the host processing device 2b and the client processing device 3a. For example, a processing unit of the laptop Z may be configured to execute the functions of both the host processing device 2b and the client processing device 3a.

The host processing devices 2a, 2b each may send the respective metadata to each of the client processing device 3a, 3b, 3c.

A central control unit (i.e. “base unit”) 4 of the video conference system in the meeting location may be the host processing device 2a.

Thus, it can be seen that a single device may be both the host and client processing device. For example, in this example, the laptop Z may comprise the sensor 1b, and it may comprise one or more processors for executing the functions of the host processing device 2b and the client processing device 3a. For example, the CPU of the laptop Z may be used to generate the metadata and to generate the signal associated with the participant for video communication. The invention can be carried out in a distributed way such that multiple devices may be involved for generating the signal associated with a participant of video communication, instead of using a centralised system.

The host processing devices 2a, 2b may send the respective metadata to any client processing device 3a, 3b, 3c by a wireless connection or a wired connection between the host processing device 2a, 2b and the client processing device 3a, 3b, 3c.

The host processing devices 2a, 2b may send the respective metadata by a broadcasting network or a point-to-point network.

The host processing device 2a, 2b may send the respective metadata to the client processing device 3a, 3b, 3c by a data bus, when a single device (e.g., the laptop Z) is both the host and client processing device.

Both the broadcasting and the point-to-point network may be either a wired or a wireless network.

The point-to-point wireless network may be an ad-hoc network. For example, Wi-Fi, Bluetooth interfaces may be used for achieving the point-to-point wireless communication, or any wireless or wired communications protocol. Examples of wireless communications protocol are provided in the present specification. Based on the received respective metadata from the host processing devices 2a, 2b, the client processing device 3a may determine whether to request at least a part of the respective sensor signal acquired by at least one of the at least two sensors 1a, 1b.

In this example, each of the client processing devices 3a, 3b, 3c may determine to request at least a part of the respective sensor signal acquired by any of the sensors 1a, 1b. Then, each of the client processing device 3a, 3b, 3c may send a request to the relevant host processing devices 2a, 2b.

In one aspect of the invention, a client processing device 3a, 3b, 3c may implicitly request at least a part of the respective sensor signal from the host processing device 2a, 2b assuming the client processing device always requests the respective signal from the host processing device 2a, 2b. Said request may thus happen ‘by default’ without requiring an action from either client processing device 3a, 3b, 3c or host processing device 2a, 2b. When doing so, the client processing device 3a, 3b, 3c is not expected to send an explicit request to the host processing device 2a, 2b for accessing at least a part of the respective sensor signal of the host processing device 2a, 2b. Instead, the host processing device 2a, 2b may be configured to recognize the client processing device 3a, 3b, 3c to be implicitly requesting at least a part of the respective sensor signal of the host processing device 2a, 2b. The host processing device 2a, 2b may send the respective sensor signal of the host processing device 2a, 2b to said client processing device 3a, 3b, 3c without requiring to receive a request from the client processing device 3a, 3b, 3c.

The host processing devices 2a, 2b respectively send the at least a part of the respective sensor signal to the client processing devices 3a, 3b, 3c upon receiving their request(s). The transmission of the metadata, the request, and the at least a part of the respective video signal may be conducted by a same or different means, e.g., by using a data bus, and by using one or more communication protocols, such as Wi-Fi, or Bluetooth, or any other communication protocols known to the skilled person.

In addition, the transmission of a same type of data, e.g., the metadata, may be done in a same or different way(s). For example, in FIG. 1, the metadata generated by the host processing device 2b may be send to the client processing device 3a via an internal bus, as the laptop Z is both the host processing device 2b and the client processing device 3a.

The metadata generated by the host processing device 2a may be send to the client processing device 3a by a different means of communication, such as Wi-Fi, or any other communication protocol.

The client processing devices 3a, 3b, 3c may each generate the signal associated with the participant for video communication based on the at least a part of the respective sensor signal received from the host processing devices 2a, 2b.

The client processing devices 3a, 3b, 3c may each send the generated signal associated with the participant to a video communication device 5 for conducting video communication with a remote participant of video communication.

The term “remote participant” may refer to that the remote participant is not present in the meeting location. In other words, the remote participant may be physically separated in space from the participant, from the meeting location, and/or from the at least two sensors, such that the remote participant can only know what is happening within the meeting location based on the generated signal associated with the participant.

The laptop Z may be the video communication device 5, as shown in FIG. 1. In other words, a single device may be one or more of the host processing device, the client processing device, and the video communication device. The single device may comprise the sensor.

Alternatively, any other devices, e.g., the base unit 4, may be the video communication device 5.

The video communication device 5 may be a device running a video communication software.

The video communication device 5 may be a virtual reality platform, an augmented reality platform, or a mixed reality platform.

The video communication device 5 may be a server, e.g., of a video communication service provider. The video communication service provider may be a Unified Communications and Collaboration, UC&C, service provider. Examples of UC&C service include: Teams, Zoom, Skype, etc.

The video communication device 5 may provide the function of a UC&C client.

The video communication device 5 may be a virtual camera. The generated signal associated with the participant for video communication may be exposed to a UC&C client via the virtual camera.

Each of the host processing devices 2a, 2b may comprise:
a router function module 21 for receiving the respective sensor signal, receiving the request from one or more client processing device, and sending the at least a part of the respective sensor signal to the client processing device upon receiving the request;
a determination module 3a, 3b, 3c responsible for ascertaining the specific implicitly or explicitly requesting client processing device to which at least a part of the respective sensor signal will be directed. It's noteworthy that the host processing device is not mandated to immediately transmit at least a part of the respective sensor signal to the client processing device upon request reception. The host processing device retains the option to delay transmitting at least a part of the respective sensor signal to the client processing device subsequent to request reception. Additionally, the determination module can be seamlessly integrated as part of the router function module.
an analysis function module 22 for analysing the respective sensor signal for generating the respective metadata; and
a metadata router function module 23 for sending the generated metadata to the client processing device.

The client processing device 3a, 3b, 3c may comprise:
a metadata receiver function module 31 for receiving metadata from one or more host processing devices 2a, 2b;
a determination function module 32 for determining, based on the received respective metadata, whether to request at least a part of the respective sensor signal;
a transceiver function module 33 for sending the request to the host processing device 2a, 2b, and receiving the at least a part of the respective video signal from the host processing device 2a, 2b; and
a composing function module 34 for generating the signal associated with the participant for video communication.

The client processing devices 3b, 3c may perform functions analogously as the client processing device 3a, which will not be discuss in detail.

Any of the host/client processing device 2a, 2b, 3a, 3b, 3c and the video communication device 5 may include a processor, such as a central processing unit (CPU), microcontroller, or microprocessor.

Any of the host and client processing device 2a, 2b, 3a, 3b, 3c and the video communication device 5 may be configured to execute program codes stored in a memory, in order to carry out functions and operations of any of the host and client processing device 2a, 2b, 3a, 3b, 3c and the video communication device 5, respectively.

The memory may be one or more of a buffer, a flash memory, a hard drive, a removable medium, a volatile memory, a non-volatile memory, a random access memory (RAM), or another suitable device. In a typical arrangement, the memory may include a non-volatile memory for long term data storage and a volatile memory that functions as system memory for a device executing functions of any of the host and client processing device 2a, 2b, 3a, 3b, 3c and the video communication device 5. The memory may exchange data with any of the host/client processing device 2a, 2b, 3a, 3b, 3c and the video communication device 5 over a data bus. Accompanying control lines and an address bus between the memory and any of the host/client processing device 2a, 2b, 3a, 3b, 3c and the video communication device 5 may also be present.

Functions and operations of any of the host/client processing device 2a, 2b, 3a, 3b, 3c and the video communication device 5 may be embodied in the form of executable logic routines (e.g., lines of code, software programs, etc.) that are stored on a non-transitory computer readable medium (e.g., the memory) of the device executing functions of any of the host/client processing device 2a, 2b, 3a, 3b, 3c and the video communication device 5. Furthermore, the functions and operations of the host/client processing device 2a, 2b, 3a, 3b, 3c and the video communication device 5 may be a stand-alone software application or form a part of a software application that carries out additional tasks related to said device. The described functions and operations may be considered a method that said device is configured to carry out. Also, while the described functions and operations may be implemented in software, such functionality may as well be carried out via dedicated hardware or firmware, or some combination of hardware, firmware and/or software.

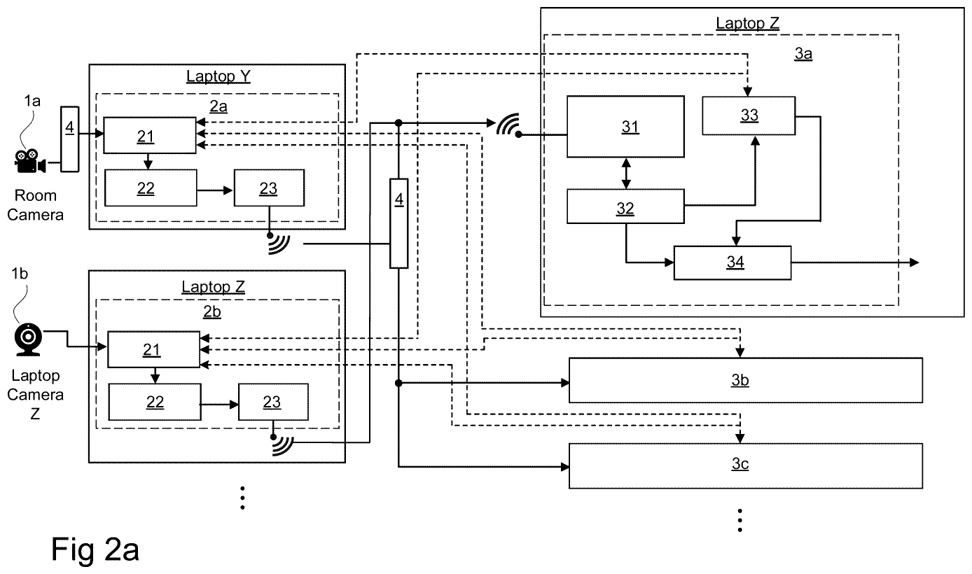

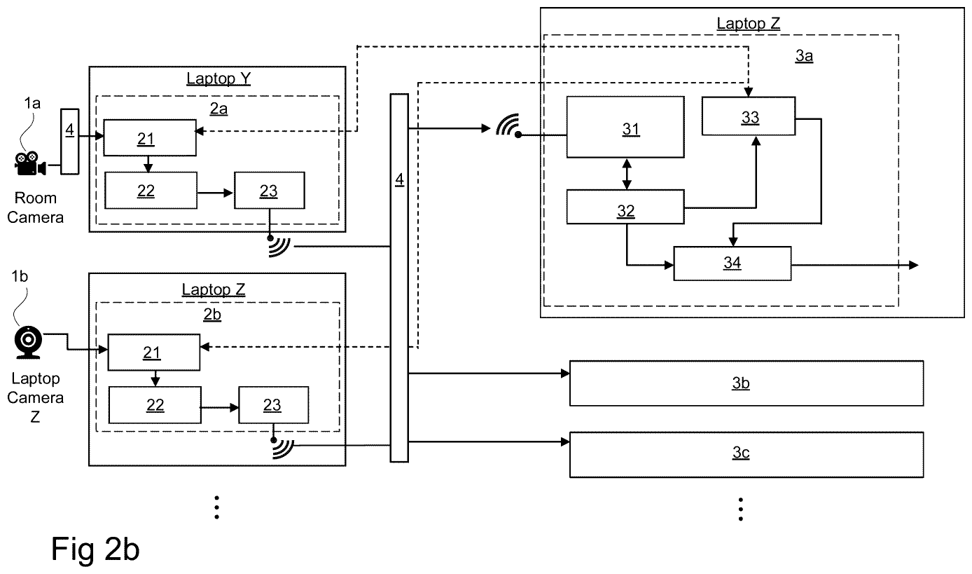

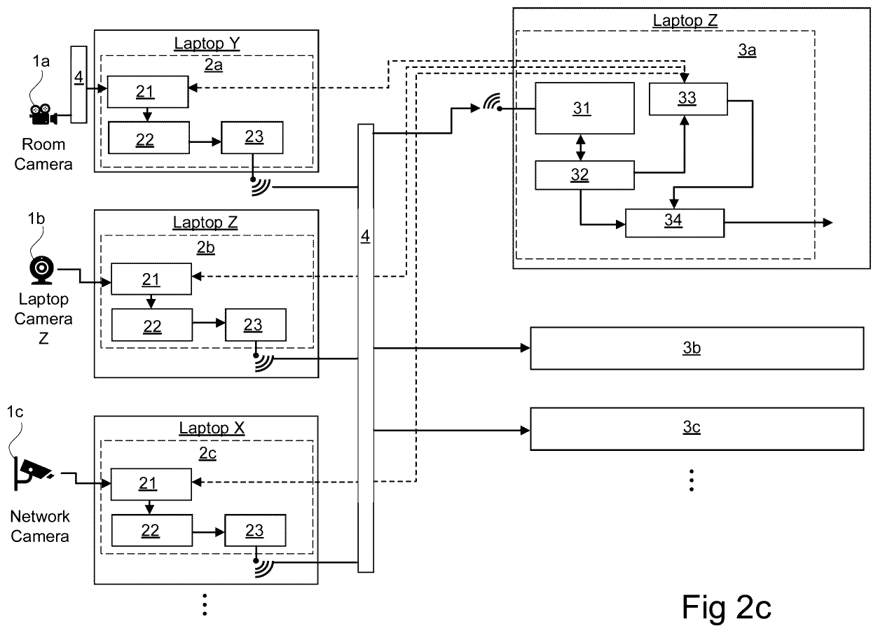

The configuration and examples provided in the previous examples are applicable to the example of FIG. 2a, which will not be discussed again.

In the example of FIG. 2 a, a laptop Y is the host processing device 2a. The laptop Y may be provided in the meeting location or at a different location. The laptop Y may be an ad-hoc host processing device. That is, the laptop Y may be temporarily used as the host processing device for a sensor. This may offload the processing workload of other devices of the system, such as the base unit 4.

In other words, a device not previously involving in the video communication can be used as an ad-hoc host/client processing device, e.g., for offloading other devices.

The base unit 4 may receive the sensor signal from the sensor 1a, and forward the sensor signal to the host processing device 2a.

The base unit 4 may receive the metadata from any of the host processing device 2a, 2b, and forward to the client processing devices 3a, 3b, 3c.

A node, such as the base unit 4, may receive the metadata from at least one host processing device 2a, 2b, and forward to at least one of the client processing device 3a, 3b, 3c.

The configuration and examples provided in the previous examples are applicable to the example of FIG. 2b, which will not be discussed again.

In FIG. 2b, the base unit 4 may receive the metadata from both of the host processing devices 2a, 2b, and forward to each of the client processing devices 3a, 3b, 3c.

This may allow all the client processing devices 3a, 3b, 3c to have access to all the metadata. That is, all the client processing devices 3a, 3b, 3c may be able to access the sensor signals acquired by all the sensors.

The metadata may be filtered by any of the host processing devices 2a, 2b, the base unit 4, and/or the client processing devices 3a, 3b, 3c, such that not each piece of metadata is automatically broadcasted from the host processing device 2a, 2b to any client processing device 3a, 3b, 3c, via the base unit 4.

Any of the host processing devices 2a, 2b may send the at least a part of the respective sensor signal to the base unit 4 for forwarding to any of the client processing devices 3a, 3b, 3c (not shown in FIG. 2b).

Alternatively, or in combination, the at least a part of the respective sensor signal may be sent via a wireless connection or a wired connection between the host processing devices 2a, 2b and the client processing devices 3a, 3b, 3c. The at least a part of the respective sensor signal may be send by a broadcasting network or a point-to-point network.

The transmission of the at least a part of the respective sensor signal may be conducted by one or different ways, such as via a wire or wirelessly.

The transmission of the at least a part of the respective sensor signal may be conducted by one or different communication protocols, such as Wi-Fi, or Bluetooth, or any other communication protocol.

The transmission of the request may be performed analogously as the transmission of the at least a part of the respective sensor signal or the transmission of the metadata.

The transmission of the request may be performed differently, e.g., by using Wi-Fi, or a different communication protocol, from the transmission of the at least a part of the respective sensor signal and/or the transmission of the metadata, e.g., by using Bluetooth, or a different communication protocol.

Each of the client processing devices 3a, 3b, 3c may determine to request at least a part of the respective sensor signal acquired by any of the sensors 1a, 1b. Each of the client processing device 3a, 3b, 3c may send a request to any host processing device 2a, 2b.

In some embodiments, the determination module may be part of the router function module. The determination module includes a means for determining whether a client processing device should receive at least part a of the respective sensor signal at a given point in time. The method of determination may, for example, be based on metadata that is received from host processing device(s) or client processing device(s) or via other means. In some other embodiments, the determination may be based on at least one of:
pre-determined rules, context sensitive rules or artificial intelligence for determining whether a client processing device should receive at least a part of the respective sensor signal at a given point in time. When a client processing device requests at least part of the respective sensor signal of the host processing device, the determination module may deny access to said at least part of the respective signal or only grant access to the said at least part of the respective signal in a delayed manner. Further, when a client processing device requests at least a part of the respective signal of the host processing device is determined to be implicit or ‘by default’, the determination module of the host processing device will determine whether the client receives the signal at a point in time.

In some exemplary embodiments, a means for determination may be set to comply with a maximum number of at least part of the respective sensor signals that can be sent from said host processing device. The maximum number may be pre-determined, configurable or context adaptive. In further exemplary embodiments, a means for determination may be set to comply with a maximum computational and/or bandwidth budget that the system can use for generating and/or sending at least a part of the respective sensor signals. Said maximum budget may be pre-determined, configurable or context adaptive. In further exemplary embodiments, a means for determination may be set to a metric for optimizing a user experience. For example, in some conditions the user experience may be improved by increasing the number of at least part of the sensor signals that are sent towards the users. In some other conditions, the user experience may be improved by decreasing the number of at least part of the sensor signals sent. In some other conditions, the means for determination may determine that the user experience will improve by not sending at least a part of the respective sensor signal at a given point in time. The means for determination can thus influence the user experience by adapting the number of at least part of the respective sensor signals that can be sent from the host processing device to the client processing device(s) and/or adapting at least a part of the respective sensor signals that are being sent. The means for determination may influence the means to generate at least a part of the signals from the original sensor signal. For example, when there are many requests from client processing devices for an at least part of the respective sensor signal, the means for determination may configure the means to transform to enable said at least part of the respective sensor signals to be sent to said client processing devices. For example, the bandwidth requirements may be reduced by increasing compression. For example, parts of the signal may be removed depending on the requesting client processing device. For example, at least a part of the sensor signal that is sent to certain requesting client processing device may focus on the signal data that specifically relates to a user that is linked to said requesting client processing device.

At least a part of the respective sensor signal that is sent to one client processing device may be different to at least a part of the respective sensor signal that is sent to another client processing device by having different transformations being applied to the respective sensor signal. Two variants of at least a part of the respective sensor signal may be sent to the same client processing device, each having a different transformation applied to the respective sensor signal.

Transformations may include signal processing operations such as cropping, blurring, blending, composing, filtering, enhancing, segmenting, analysis, compression, tracking, panning, zooming, blending 3d imaging, speech processing, recognition and others. Transformations may include providing parameters to a model that outputs the at least part of the sensor signal based on the parameters. Transformations may include selecting-and composing of sub-signals that result in the at least part of the sensor signals.

Transformations may be different for each of the client processing devices.

When the client processing devices are requesting more than the determined number of at least part of the respective sensor signals, the determination may include a selection process that will select a subset of requesting client processing devices from the total number of requesting client processing devices. The selected subset may change over time, and these changes may stop the host processing device from sending an at least part of the respective sensor signal to a first client processing device at one point in time and start sending an at least part of the respective sensor signal to a second client processing device. The selected subset may change, for example, due to receiving a request for at least a part of the respective sensor signal from client processing device. The selected subset may change, for example, due to receiving an indication from the client processing device that at least a part of the respective sensor signal is not requested anymore. The selected subset may change, for example, due to the subset depending on a time-varying state that is comprised of metadata, pre-defined rules, context sensitive rules or artificial intelligence.

The selection mechanism may select the subset based on a priority mechanism. The priority is assigned, statically or dynamically, to each of the requesting client processing devices. The priority is used to determine the subset of client processing devices that receives an at least part of the respective sensor signal. The priority may be based on metadata information that is available to the host processing device. For example, the priority may be based on the viewing direction of the users in the meeting location. For example, the viewing direction of the users in the meeting room may be interpreted relative to the sensors in the meeting location, relative to each other or other real and/or virtual objects and/or subjects in the meeting location. These viewing directions may influence the priority in a positive manner. For example, when the sensor that is represented by the host processing device has a better view of the user in the meeting room compared to the other sensors that are available. The viewing directions may influence the priority. For example, when the sensor that is represented by the host processing device has a worst view of the user in the meeting room compared to other sensors that may be available, the host processing device may thus use information from other sources (for example from other host processing devices, from client processing devices, and from other sources) to determine the priorities at any given point in time. The priorities may dynamically adapt to the conditions and these changes may impact the client processing devices that receive at least a part of the respective sensor signal. Another example of a factor that may have an impact on the priority is the verbal behavior of the users in the meeting location. The client processing device that is associated to a user who is talking may have higher priority for example. Another example of a factor that can have an impact on the priority is the anticipated impact on the meeting dynamics of the related generated signal associated with the participant of video communication. The client processing devices associated to users who have a more active participation in the meeting dynamics may be given higher priority for example. Many other factors may also have an impact on the priorities that are related to the implicitly or explicitly requesting client processing devices. Multiple factors may also be combined resulting in a combined priority metric.

The selection mechanism may select the subset based on the history of earlier selections. The selection may, for example, restrict a client processing device from receiving an at least part of the respective sensor signal from the host processing device for longer than a maximum duration. When said duration is exceeded, the host processing device may stop sending at least a part of the respective sensor signal to that client processing device for an amount of time. In another example, the history is used to ensure that the different client processing devices get access to an at least part of the respective sensor signal from the host processing device for a similar amount of time. The amount of time for providing access to at least a part of the respective sensor signal may be normalized based on the amount or length of requests that the host processing device received from the client processing devices. Normalization may also be related to the importance that each client processing device has in the meeting, or it may be related to any other metric that alters the weights of the requesting client processing device towards the host processing device.

The selection mechanism may also be based on mechanisms such as a round-robin principle, a random selection principle, a weighted random sampling method, a first-in first-out (FIFO) method, a first-in last-out (FILO) method or any other method that provides subsets from a selection of implicitly or explicitly requesting client processing devices.

The determination and selection mechanism may integrate knowledge on how to provide a meaningful meeting experience, either via pre-determined rules or via a dynamically adaptive system that, for example, uses user actions or feedback that implicitly or explicitly indicate preferences towards the results of the determination and selection mechanism.

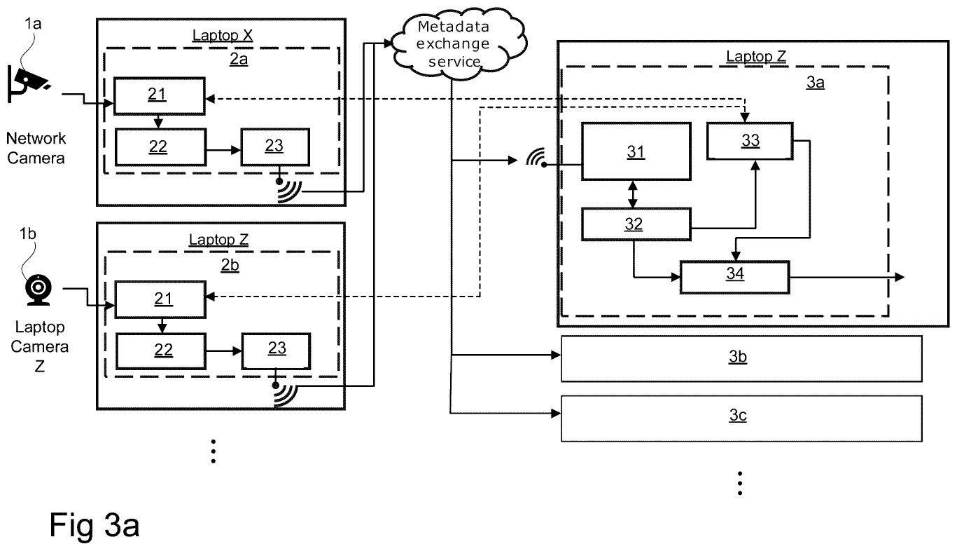

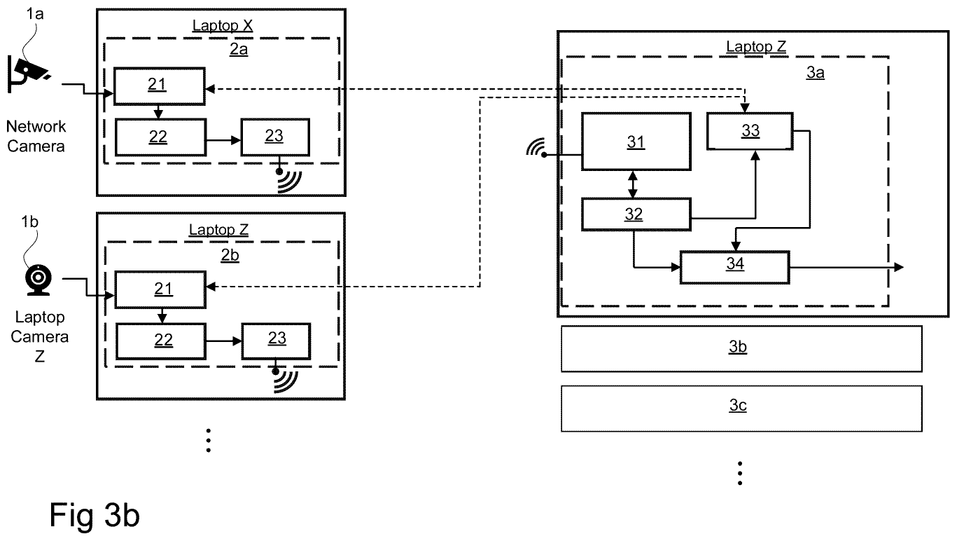

The transmission of the request and the transmission of the at least a part of the respective sensor signal between the host processing devices and the client processing devices 3b and 3c are not shown in FIGS. 2b, 2c, 3a, and 3b.

The configuration and examples provided in the previous examples are applicable to the example of FIG. 2c, which will not be discussed again.

In FIG. 2 c, a third sensor 1c is provided, which is a network camera. A laptop X (or any other devices, such as the laptop Y and Z, the base unit 4) may be a host processing device 2c. The laptop X may be provided in the meeting location or at a different location. The laptop X may be an ad-hoc host processing device.

In FIG. 2c, the base unit 4 may receive the metadata from the host processing devices 2a, 2b, 2c, and forward to the client processing devices 3a, 3b, 3c.

This may allow all the client processing devices 3a, 3b, 3c to have access to all the metadata. That is, all the client processing devices 3a, 3b, 3c may be able to access the sensor signals acquired by all the sensors 1a, 1b, 1c.

The metadata may be filtered by any of the host processing devices 2a, 2b, 2c, the base unit 4, and/or the client processing devices 3a, 3b, 3c, such that not each piece of metadata is automatically broadcasted from the host processing device 2a, 2b, 2c to each client processing device 3a, 3b, 3c, via the base unit 4.

The configuration and examples provided in the previous examples are applicable to the example of FIG. 3a, which will not be discussed again.

In FIG. 3a, the sensor 1a is the network camera and the sensor 1b is the laptop camera Z. The laptop X (or any other devices, such as the laptop Y and Z) may be the host processing device 2a. The laptop Z may be the host processing device 2b.

No central control unit, e.g., the base unit 4, is used in the example of FIG. 3a.

The host processing devices 2a, 2b may send the respective metadata to the client processing devices 3a, 3b, 3c by using a metadata exchange service.

The metadata exchange service may receive the respective metadata from one or more host processing devices 2a, 2b, and forward to one or more client processing devices 3a, 3b, 3c. The metadata exchange service may be a cloud based service.

Besides simply forwarding the generated metadata, the metadata exchange service may have additional functions.

The metadata exchange service may store the respective metadata. The metadata exchange service may store the metadata and optionally aggregate the received metadata into a consistent state. The metadata exchange service may expose the stored/aggregated metadata to the client processing devices 3a, 3b, 3c, e.g., in an asynchronous manner.

The metadata exchange service may store and/or update a state of the respective metadata. For example, the metadata exchange service may hold and store a state of the metadata such that it can be retrieved later, e.g., by any of the host processing devices 2a, 2b and/or by any of the client processing devices 3a, 3b, 3c. The metadata exchange service may update the state of the metadata. The state of the metadata may be queried, e.g., by any of the host processing devices 2a, 2b and/or by any of the client processing devices 3a, 3b, 3c, in an asynchronous manner.

The metadata exchange service may filter the respective metadata, e.g., based on a predetermined filtering mechanism. For example, the metadata exchange service may have a query-based filtering mechanism, e.g., via graphql. For example, the metadata exchange service may have a pub-sub functionality, intelligently merge/process metadata, e.g., relating a part of a first metadata relating to identification of a person of a first sensor signal acquired by the sensor 1a to a part of a second metadata relating to identification of the same person of a second sensor signal acquired by the sensor 1b.

Either the sender or the receiver of metadata using the metadata exchange service may filter the metadata, e.g., for finding out which metadata is of interest. For example, any of the host processing devices 2a, 2b may filter the metadata for only sending the metadata of interest. Any of the client processing devices 3a, 3b, 3c may indicate which metadata is of interest to receive. This may reduce the number of metadata transferred between the host and client processing devices. This may reduce the bandwidth required for sending and receiving metadata.

The configuration and examples provided in the previous examples are applicable to the example of FIG. 3b, which will not be discussed again.

FIG. 3b is an example of the host processing devices 2a, 2b sending the respective metadata by broadcasting. The broadcasting may be achieved by using a broadcasting network. The broadcasting network may be either a wired or a wireless network. For example, Wi-Fi, Bluetooth interfaces may be used for achieving the broadcasting wireless communication.

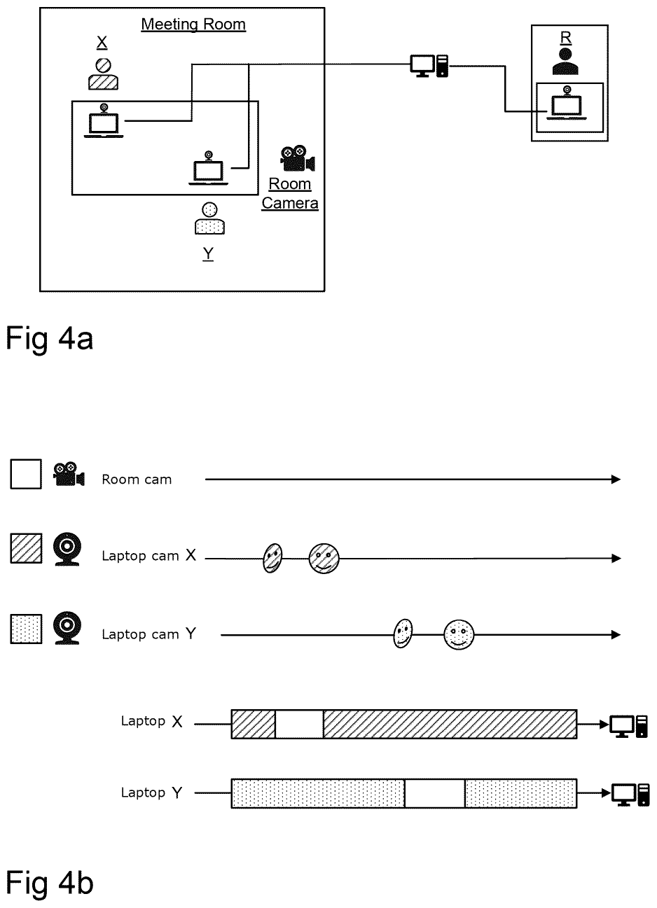

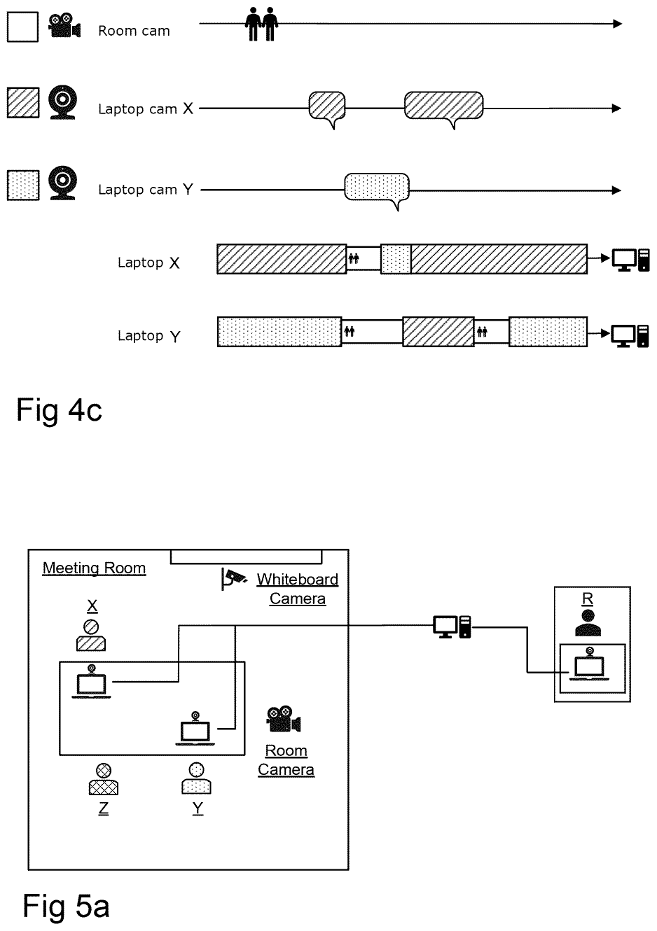

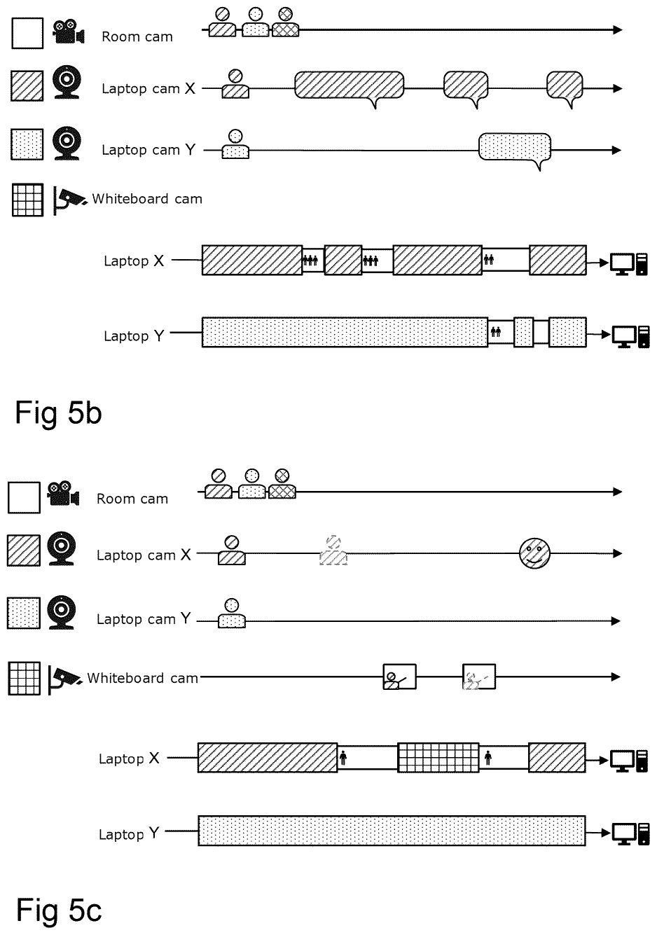

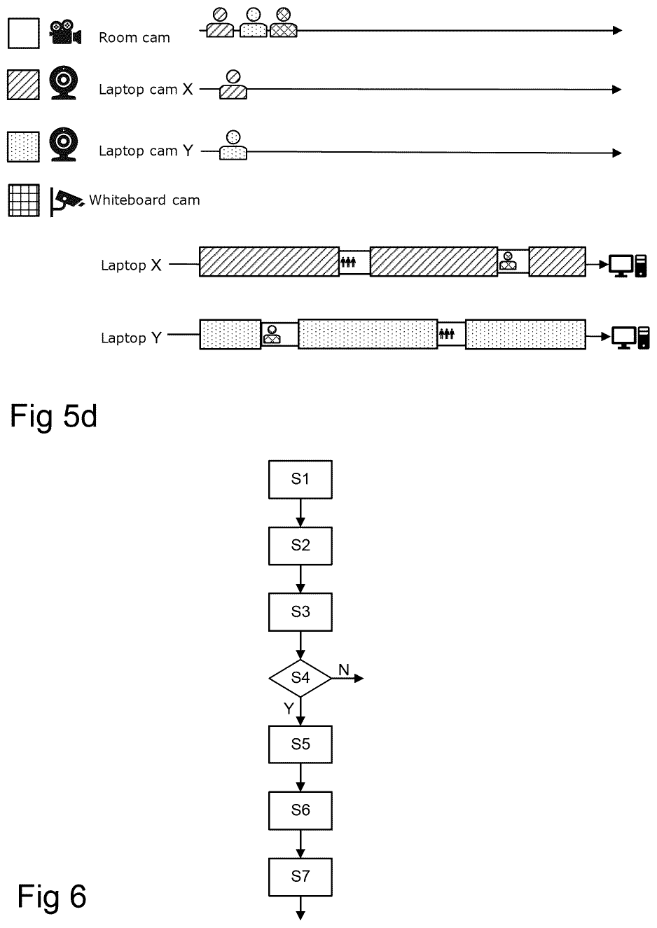

In the examples of FIGS. 3a-3b, the system is entirely decentralised by removing any central devices, such as the central control unit, e.g., the base unit 4, or the room camera. The invention can be carried out by a distributed system comprising no central devices at all. In connection with FIGS. 4a-5d, examples of the video communication, and the signal associated with participants of the video communication will be discussed in more detail.

In connection with FIGS. 4a-6, the method of generating a signal associated with the participants X, Y for video communication will be discussed in more detail. Any signal associated with other participants, such as the remote participant R, may be generated analogously, which will not be discussed in detail.

FIG. 4a illustrates an example of a video communication.

The video communication may comprise three participants: two local participants X and Y at a table in the meeting room, and one remote participant R. Each of the participants X, Y and R is provided with an individual laptop X, Y, R having a laptop camera X, Y and R, respectively.

The individual devices (e.g., laptops) of the participants are connected in a way such that they are able to interchange information with each other for conducting a video communication. There may be additional devices provided in-between the individual devices for the purpose of data communication and/or for the purpose of video communication.

The method comprises providing at least two sensors in a meeting location, each sensor acquiring a respective sensor signal (S1). At least one of the acquired sensor signals comprises information related to the participant.

In FIG. 4a, there are three sensors provided in the meeting room, i.e., a room camera, the laptop camera X, and the laptop camera Y, each acquiring a respective sensor signal.

The participant of video communication may be one or more persons, such as the local participants X, Y and remote participant R. The participant may actively, e.g., speakers, or passively, e.g., listeners, participating the video communication. The term “remote” may refer to that the participant is physically separated in space from other local participants, from the meeting location, and/or from the sensors provided in the meeting location, such that the remote participant can only know what is happening in the meeting location based on the generated signal associated with the participants. It may then also refer to that the participant is in the same room but connected to a different network, i.e., using personal mobile data.

The participant may be one or more non-human objects, e.g., a robot, and a conference room, a device, involving in the video communication. However, in this example the meeting room is not a participant. Thus, no signal associated with the meeting room is generated in this example.

Any available devices, such the central control unit of the video conference system of the meeting room, the laptop X, Y and R, may be the host processing device (executing the function of the host processing device).

One host processing device may be provided to each of the sensors such that each of the at least two sensors may have an individual host processing device. Alternatively, one sensor may share the same individual host processing device with another or other sensor(s).

In this example, the laptop X, Y may be the client processing devices, respectively, for generating the signals associated with the local participant X and Y for video communication.

The generated signals may be sent to a video communication device for conducting video communication with the remote participant R. The laptop X, Y may be the video communication device for providing the function of a UC&C client.

The video communication device may be a device running a video communication software.

The video communication device may be a server, e.g., of a video communication service provider. The video communication service provider may be a Unified Communications and Collaboration, UC&C, service provider. Examples of UC&C service include: Teams, Zoom, Skype, etc.

The video communication device may provide the function of a UC&C client.

The video communication device may be a virtual camera. The generated signal associated with the participant for video communication may be exposed to a UC&C client via the virtual camera.

The upper part of FIG. 4b schematically shows the three sensor signals acquired by the room camera, the laptop camera X and Y, respectively, over time.

The method may comprise the room camera acquiring a room camera signal comprising information related to the meeting room and the participants X and Yin the meeting room.

The method may comprise the laptop camera X acquiring the sensor signal (“sensor signal X”) comprising information related to the participant X.

The method may comprise the laptop camera Y acquiring the sensor signal (“sensor signal Y”) comprising information related to the participant Y.

The method may comprise the room camera acquiring the sensor signal (“room camera signal”) comprising information related to the meeting room and the participants X and Yin the meeting room.

The information related to a participant may refer to that the information directly or indirectly related to the participant. In other words, said information doesn't need to directly relate to the participant X, Y themself. For example, one participant being a person is in a meeting room, and when another person or another entity in the same meeting room changes their status, information representing the another person/entity and/or the changes of the another person/entity is also related to the person, although said information is only indirectly related to the person. In other words, information related to other participants or entities involving in the video communication may also be considered to be related to said participant.

The sensor signal X may comprise information about the participant X turning his face away from the laptop camera X, and then turning his face back.

The sensor signal Y may comprise information about the participant Y turning his face away from the laptop camera Y, and then turning his face back.

The method comprises providing a host processing device for each of the at least two sensors for receiving and analysing the respective sensor signal for generating respective metadata (S2). The respective metadata comprises information about the respective sensor signal. The respective metadata X and Y may comprise information about the respective sensor signal X and Y.

The metadata may comprise information of a property of the respective sensor signal, such as a resolution, a framerate of the respective sensor signal.

The metadata may comprise information of the presence or availability of a respective sensor signal.

The metadata may comprise information of detection of one or more events in the sensor signal, such as detection of a person, detection of a speaker, detection of a gesture or movement of a person, identification of a person, identification of a speaker, identification of a gesture or movement of a person, identification of a position of a person relative to an entity (such as a white board and/or a podium), absence of a person, estimated capture quality of a person, spatial information of a detected person in camera space or in world space, and recognition of an audio signature of a person.

The gesture or movement of a person may comprise: a movement of a lip, raising a hand, standing up, shaking heads, pointing towards an object, gazing at an object, etc.

The metadata may comprise information of identification of an object pointed towards by a participant, identification of a position or a state of an object pointed towards by a participant.

The metadata may comprise information of identification of a position and/or orientation of a head of a person, detection of a head of a person orienting towards an object, a gazing direction of a person, and detection of an indicator related to a mental state of a person.

The metadata may comprise information of detection of one or more events in the sensor signal, such as detection of an entity (non-human object, such as a furniture and a collaboration equipment), identification of an entity, detection of a change of an entity (such as a movement), absence of an entity, estimated capture quality of an entity, spatial information of a detected entity in camera space or in world space, and identification of a visual fingerprint of an entity.

The metadata may comprise information of detection of one or more events in the sensor signal, such as an overall audio level, and detection of an audio signature, etc.

The metadata may comprise information representing a singular event. The singular event may comprise recognisable action or occurrence, such as identification of a person entering a frame.

The metadata may comprise information representing an event being continuous in nature, e.g., the framerate of the video signal, detection of presence of a person, detection of a person located at a bounding box in the frame, etc.

The metadata X and Y may comprise information about the detection of the participant X and Y turning his face away from the laptop camera X, Y respectively, and the detection of the participant X and Y turning his face back, respectively.

The method comprises each host processing device sending the respective metadata to a client processing device (S3).

The laptop X, Y may be two client processing devices X, Y, respectively, for generating the signals associated with the local participant X and Y for video communication.

The client processing device may comprise a device body (e.g., a laptop body). At least one of the at least two sensors may be attached to the device body. For example, the laptop X may be the client processing device X and the laptop camera X may be attached to the laptop body of the laptop X.

The host processing device may comprise a device body (e.g., a laptop body). At least one of the at least two sensors may be attached to the device body. For example, the laptop Y may be one host processing device. And the laptop camera Y may be embedded in the laptop body of the laptop Y.

One device may comprise at least one of the sensors and act as the client processing device. The sensor may be an integral part of the device or an external sensor operatively connected to the device, e.g., by a USB cable. For example, the sensor may be a laptop camera, or an auxiliary camera operatively connected to the laptop by a USB cable, and the laptop may execute the functions of the client processing device. Thus, the client processing device may receive sensor signals from its own laptop camera or from the connected auxiliary camera.

Alternatively, or in combination, one device may comprise the sensor and another device may act as the client processing device. For example, a first laptop as the client processing device may receive sensor signals from its own laptop camera and/or from laptop cameras of other laptops within a same meeting room.

Analogously, one device may comprise at least one of the sensors and act as the host processing device, or one device may comprise the sensor and another device may act as the host processing device. Alternatively, or in combination, one device may be both the host and client processing device, or two different devices may be the host and client processing device, respectively.

The method comprises the client processing device determining, based on the received respective metadata, whether to request at least a part of the respective sensor signal acquired by at least one of the at least two sensors (S4).

The method may comprise the client processing device X, Y determining based on the received respective metadata and a strategy of generating the signal associated with the participant for video communication.

The strategy may be based on metadata and/or additional data (e.g., from an external device). The strategy may be directly or indirectly related to any combination of said data. The strategy of generating the signal associated with the participant for video communication may comprise one or more rules for facilitating the generation of an improved signal associated with the participant for video communication. For example, the strategy may indicate how the signal associated with the participant for video communication should be created by taking into account perceptual models (i.e. what should the signal be constructed in order to optimally convey certain information to the users (e.g., a remote participant) of the signal.

For example, in order to optimally convey a conversation between the participant X and the participant Y, the strategy may describe that the signal associated with the participant X for video communication should comprise 10 seconds of the sensor signal X, following by 5 seconds of the sensor signal Y, following by 3 seconds of the room camera signal, and following by 10 seconds of the sensor signal X, . . . , as a simple example.

For example, when the metadata comprising information of detection of the participant X looking at a shared screen in the meeting room, the additional data (e.g., the content displayed on the shared screen) may be used to determine whether a part of the sensor signal capturing the shared screen should be requested or not. For example, if the content displayed on the shared screen is something that the remote participant R cannot see (e.g., a locally shared application), a part of the sensor signal capturing the shared screen should be requested such that the generated signal can provide it to the remote participant R. Alternatively, a virtual camera may be created for representing this content and is exposed as a virtual sensor. Thus, this virtual sensor may be considered as a sensor of the invention, which can acquire a sensor signal, and a metadata based on which may be generated.

The strategy may comprise to generate the signal associated with the participant for video communication based on a list of different metadata comprising information about different sensor signals, in a certain order. If the respective metadata is the same as any metadata of the list of metadata, it is determined to request the at least a part of the respective sensor signal. If the metadata is not the same as any of the list of metadata, no request is sent.

For example, if the sensor signal and its metadata comprise information of a participant raising a hand, and one metadata of the list of metadata is about a person raising a hand, it is determined to request the at least a part of the respective sensor signal. For example, if the respective metadata indicating a high resolution of the sensor signal and one metadata of the list of metadata is about the high resolution of the sensor signal, it is determined to request the at least a part of the respective sensor signal.

The strategy may comprise to request at least a part of one or more sensor signals to generate the signal associated with the participant for video communication by default. The condition “by default” may refer to that a part of certain sensor signal is requested to be used to generate the signal associated with the participant, when no other parts of sensor signal(s) is deemed more appropriate. For example, a part of the sensor signal X is used to generate the signal associated with the participant X, when no parts of the room camera signal or of the sensor signal Y is requested to generate the signal associated with the participant X.

The strategy may comprise if the metadata X, Y comprise information about the detection of the participant X or Y turning his face away from the laptop camera X or Y, it is determined to request the at least a part of the room camera signal.

The strategy may comprise if the metadata X, Y comprise information about the detection of the participant X or Y facing the laptop camera X or Y, it is determined to request the at least a part of the sensor signal X or Y, respectively.

The strategy may be predetermined, e.g., based on the settings and requirements of the video communication, such as the bandwidth of the video communication, the number of the participants, etc.

The strategy may be created and/or changed, e.g., by a participant of video communication, during the video communication. The participant may create a new strategy, delete or change a part of the existing strategy, e.g., based on requirements of the video communication.

For example, the participant X in the meeting room may decide that there should be more context from the meeting room than personal views, e.g., based on his personal preference. The participant X may change the strategy such that the percentage of the sensor signals of personal views is reduced when generating the signal associated with the participant for video communication. Alternatively, the participant X may provide his feedback to a video communication system or any other device, which will change the strategy according to his feedback.

For example, when there are too many participants raising hands, a remote participant may change the strategy to stop using the sensor signals relating to a person raising hand to generate the signal associated with the participant for video communication, such that the sensor signal associated to the person raising hand will not be requested. For example, when a remote participant is interested in the speakers of the meeting, the remote participant may change the strategy, such that the sensor signal comprising information about the person speaking will be requested for generating the signal associated with the participant for video communication.

The strategy may be created and/or changed, e.g., by a device involving in the video communication, such as the host client processing device, the client processing device, or the video communication device receiving the video signal associated with the participant for video communication from the client processing device. The device may create and/or change the strategy based on a real-time analysis of the sensor signal and/or the metadata. For example, when it is realised that metadata relating to a new type of event occurs frequently, the host processing device may change the strategy such that the sensor signal comprising information about this new type of events will be requested for generating the signal associated with the participant for video communication.

The method comprises upon determining to request the at least a part of the respective sensor signal, the client processing device sending a request to the host processing device receiving the respective sensor signal from the at least one of the at least two sensors (S5).

The method comprises upon receiving the request, said host processing device sending the at least a part of the respective sensor signal to the client processing device (S6).

The client processing device X may send a request for requesting at least a part of the room camera signal. The client processing device X may send a request for requesting at least a part of the sensor signal X. The client processing device X may send a request for requesting at least a part of the sensor signal Y.

The client processing device Y may send a request for requesting at least a part of the room camera signal. The client processing device Y may send a request for requesting at least a part of the sensor signal Y. The client processing device Y may send a request for requesting at least a part of the sensor signal X.

Upon receiving the request, the host processing device(s) may send the at least a part of the room camera signal, of the sensor signal X, and of the sensor signal Y, to the client processing device X, respectively.

Upon receiving the request, the host processing device(s) may send the at least a part of the room camera signal, of the sensor signal X, and of the sensor signal Y, to the client processing device Y, respectively.

The method comprises the client processing device generating the signal associated with the participant for video communication based on the received at least a part of the respective sensor signal (S7).

The lower part of FIG. 4b schematically shows two generated signals associated with the participant X and Y, respectively, for video communication, based on the received at least a part of the respective sensor signals.

The signal associated with the participant X may be generated by the client processing device X. In this example, the signal associated with the participant X may be generated based on:
i) a part of the sensor signal X, when the participant X facing the laptop camera X is detected;
ii) a part of the room camera signal, when the participant X turning his face away from the laptop camera X is detected; and
iii) a part of the sensor signal X, when the participant X facing the laptop camera X is detected.

The signal associated with the participant Y may be generated by the client processing device Y. In this example, the signal associated with the participant Y may be generated based on:
i) a part of the sensor signal Y, when the participant Y facing the laptop camera Y is detected;
ii) a part of the room camera signal, when the participant Y turning his face away from the laptop camera Y is detected; and
iii) a part of the sensor signal Y, when the participant Y facing the laptop camera Y is detected.

The above may be examples of the strategy of generating the signal associated with the participant X and Y for video communication.

The client processing device may generate the signal associated with the participant based on the received at least a part of the respective sensor signal acquired by only one sensor.

The client processing device may generate the signal associated with the participant based on the received at least a part of the respective sensor signal acquired by more than one sensor.

The client processing device may generate said signal based on the received at least a part of the respective sensor signal acquired by each of the at least two sensors.

Comparing to prior art, the signal generated by the invention may improve remote participant meeting experiences by providing information acquired by different sensors interested to the remote participant. This may provide additional contextual information of what is happening in the meeting location to the remote participant, which can provide a more “on-site” meeting experience.

The client processing device may generate the signal by any of: temporal multiplexing, spatial multiplexing, and multi-modal aggregation.

The signal associated with the participant for video communication may be playable by a device involving in the video communication, e.g., a device associated with the same participant or a different participant of video communication.

The signal associated with the participant may comprise video information associated with the participant, which video information is playable/displayable by a device, e.g., a display, associated with one or more participants.

The signal associated with the participant may comprise audio information associated with the participant, which audio information is playable by a device, e.g., a loudspeaker, associated with one or more participants.

The signal may comprise any of: a video image, a video clip, and a video stream.

The configuration and examples provided in the previous examples are applicable to the example of FIG. 4c, which will not be discussed again.

The upper part of FIG. 4c schematically shows the three sensor signals acquired by the room camera, the laptop camera X and Y, respectively, over time.

The room camera signal may comprise information related to the meeting room and the participants in the meeting room. The room camera signal may comprise information about the detection of two persons in the meeting room. The room camera metadata may comprise information about the detection of two persons in the meeting room.

The sensor signal X and the metadata X may comprise information about detection of the participant X speaking.

The sensor signal Y and the metadata Y may comprise information about detection of the participant Y speaking.

The method may comprise, if one metadata comprise information about the detection of a participant speaking, it is determined to request the at least a part of the sensor signal comprising information about detection of the participant speaking.

The method may comprise, if more than one participant speaking, e.g., a dialog between more than one participant, is detected, it is determined to request:
i) at least a part of each of the sensor signals comprising information about detection of a participant speaking; and
ii) at least a part of the room camera signal comprising information about the detection of person(s) in the meeting room.

The lower part of FIG. 4c schematically shows two generated signals associated with the participant X and Y, respectively, for video communication, based on the received at least a part of the respective sensor signals.

The signal associated with the participant X may be generated by the client processing device X. The signal associated with the participant X may be generated based on:
i) a part of the sensor signal X, by default, or when the participant X speaking is detected;
ii) a part of the room camera signal, e.g., zoomed to focus on the detected persons in the meeting room, when another person (e.g., the participant Y) speaking in the meeting room is detected; and
iii) a part of the sensor signal Y, when the participant Y speaking is detected.

The strategy may comprise that a part of a certain sensor signal is used to generate the signal associated with the participant by default. For example, the strategy may comprise that a part of the sensor signal X is used to generate the signal associated with the participant X, when no other parts of sensor signal(s) is deemed more appropriate (e.g., when no participant speaking in the meeting room is detected).

The signal associated with the participant Y may be generated by the client processing device Y. The signal associated with the participant Y may be generated based on:
i) a part of the sensor signal Y, by default, or when a monolog of another person (e.g., the participant X) speaking in the meeting room is detected;
ii) a part of the room camera signal, e.g., zoomed to focus on the detected persons in the meeting room, when a dialog of more than one person in the meeting room is detected; and
iii) a part of the sensor signal X, when the participant X speaking in the meeting room is detected.

The above may be examples of the strategy of generating the signal associated with the participant X and Y for video communication.

For example, the strategy may comprise that a part of the sensor signal Y is used to generate the signal associated with the participant Y, when no other parts of sensor signal(s) is deemed more appropriate (e.g., when no participant speaking in the meeting room is detected).

Comparing with a sensor signal captured by one sensor, the signal generated by the invention may improve remote participant meeting experiences by providing information acquired by different sensors interested to the remote participant. For example, instead of only showing a single participant, showing also the room camera signal, being either an overview of the room, or a view focusing on the detected persons in the meeting room, and the sensor signals of other participants in a dialog, more information can be provided to the remote participant such that he would understand that the participants X and Y are having the dialog. Thus, an improved meeting experience, without using any additional devices.

The configuration and examples provided in the previous examples are applicable to the examples of FIGS. 5a-5d, which will not be discussed again.

FIG. 5a illustrates an example of a video communication.

The two local participants X and Y at a table in the meeting room, the remote participant R, and a new local participant Z are participants of the video communication.

Beside the room camera, the laptop camera X, and the laptop camera Y, a new sensor, i.e. a whiteboard camera, is provided in the meeting room for acquiring sensor signals comprises information related to what is happening closed to the whiteboard in the meeting room.

The upper part of FIG. 5b schematically shows the three sensor signals acquired by the room camera, the laptop camera X and Y, over time, respectively. The whiteboard camera may not, acquire any sensor signal now (the whiteboard camera may be inactivated).

The room camera signal may comprise information related to the meeting room and the persons in the meeting room. The room camera signal may comprise information related to the three participants X, Y and Z in the meeting room.

The camera metadata may comprise information about identification of the three participants X, Y and Z.

The sensor signal X may comprise information about the participant X speaking. The metadata X may comprise information about identification of the participant X and detection of the participant X speaking.

The sensor signal Y may comprise information about the participant Y speaking. The metadata Y may comprise information about identification of the participant Y and detection of the participant Y speaking.

The method may comprise if one metadata comprise information about the detection of a monologue, i.e. a single participant speaking, it is determined to request at least a part of the sensor signal comprising information about the identification of said participant and detection of said participant speaking, and at least a part of the room camera signal comprising all the identified participants.

The method may comprise if one metadata comprise information about the detection of a dialogue, i.e. a conversation between two or more persons, it is determined to request at least a part of the sensor signal comprising information about the identification of at least one person involved in the dialogue and detection of said person speaking, and at least a part of the room camera signal comprising all the persons involved in the dialogue.

The lower part of FIG. 5b schematically shows two generated signals associated with the participant X and Y, respectively, for video communication, based on the received at least a part of the respective sensor signals.

The signal associated with the participant X may be generated by the client processing device X. The signal associated with the participant X may be generated based on:
i) a part of the sensor signal X, when the monolog of the participant X is detected;
ii) a part of the room camera signal, e.g., zoomed to focus on the identified participants X, Y and Z in the meeting room, when the monolog of the participant X is detected;
iii) a part of the room camera signal, when the dialogue between the participants X and Y is detected, e.g., zoomed to focus on the identified participants X and Y involved in the dialogue; and
iv) a part of the sensor signal X when no participants is speaking in the meeting room.

The signal associated with the participant Y may be generated by the client processing device Y. The signal associated with the participant Y may be generated based on:
i) a part of the sensor signal Y, when the monolog of another person (e.g., the participant X) in the meeting room is detected;
ii) a part of the room camera signal, when the dialogue between the participants X and Y is detected, e.g., zoomed to focus on the identified participants X and Y involved in the dialogue;
iii) a part of the sensor signal Y, when the participant Y speaking is detected; and
iv) a part of the sensor signal Y, when no participants is speaking in the meeting room.

The above may be examples of the strategy of generating the signal associated with the participant X and Y for video communication.

Comparing with the examples of FIG. 4a-4c, one difference is that the participants X, Y and Z can be identified (i.e. not only being detected). Thus, the invention can take advantage of the identification of the participants to request different parts of different sensor signals capturing one or more identified participants. An improved meeting experience, without using any additional devices, may be provided.

The configuration and examples provided in the previous examples are applicable to the example of FIG. 5c, which will not be discussed again.

Besides the room camera signal, the sensor signals X and Y, the upper part of FIG. 5c also shows a sensor signal acquired by the whiteboard camera, i.e. the whiteboard signal.

The room camera signal may comprise information related to the three participants X, Y and Z in the meeting room. The camera metadata may comprise information about identification of the three participants X, Y and Z.

The sensor signal X may comprise information about the participant X. The metadata X may comprise information about detection of presence of the participant X, detection of absence of the participant X, and detection of the participant X facing the laptop camera X.

The sensor signal Y may comprise information about the participant Y. The metadata Y may comprise information about detection of presence of the participant Y.

The whiteboard signal may comprise information related to what is happening closed to the whiteboard in the meeting room. The whiteboard metadata may comprise information about detection of presence and absence of the participant X.

A single piece of metadata may be used to determine whether to request at least a part of the respective sensor signal. For example, the metadata of the detection of the absence of participant X in the sensor signal X may be used to determine to request at least a part of the room camera signal, e.g., a view of the complete meeting room.

The method may comprise using more than one piece of metadata to determine whether to request at least a part of a sensor signal

At least two pieces of metadata may be used to determine whether to request at least a part of the respective sensor signal. For example, the metadata of the detection of the absence of participant X in the sensor signal X and the metadata of the detection of the presence of participant X in the room camera signal may together be used to determine to request at least a part of the room camera signal, e.g., a zoomed view focusing on the participant X in the meeting room.

The lower part of FIG. 5c schematically shows two generated signals associated with the participant X and Y, respectively, for video communication, based on the received at least a part of the respective sensor signals.

The signal associated with the participant X may be generated by the client processing device X. The signal associated with the participant X may be generated based on:
i) a part of the sensor signal X, when the presence of the participant X is detected in the sensor signal X, e.g., the participant X facing the laptop camera X;
ii) a part of the room camera signal, e.g., zoomed to focus on the identified participant X in the meeting room, when the absence of the participant X is detected in the sensor signal X and when the presence of the participant X is detected in the room camera signal, e.g., the participant X being detected walking toward the whiteboard in the meeting room in the room camera signal;
iii) a part of the whiteboard signal, when the presence of the participant X in the whiteboard signal is detected;
iv) a part of the room camera signal, e.g., zoomed to focus on the identified participant X in the meeting room, when the absence of the participant X is detected in the whiteboard signal and when the presence of the participant X is detected in the room camera signal, e.g., walking towards his laptop X in the meeting room; and
v) a part of the sensor signal X, when the presence of the participant X is detected in the sensor signal X, e.g., the participant X facing the laptop camera X.

The above may be examples of the strategy of generating the signal associated with the participant X and Y for video communication.

For example, in above points ii) and iv), even if the absence of the participant X is detected in the respective signal and the presence of the participant X is not detected in the room camera signal, a part of the room camera signal, e.g., a view of the complete meeting room, may be used to generating the signal associated with the participant for video communication.

The signal associated with the participant Y may be generated based on the sensor signal Y, when the participant Y is detected to face his laptop Y during the video communication.

The configuration and examples provided in the previous examples are applicable to the example of FIG. 5d, which will not be discussed again.

The upper part of FIG. 5 d shows the room camera signal, and the sensor signals X and Y. The whiteboard signal is not used in this example.

The participant Z does not participant the video communication with an individual device, e.g., his own laptop. That is, the participant Z participants the video communication by using the video communication system in the meeting room, In other words, unlike the participants X and Y, no individual sensor is provided for acquiring a sensor signal of the participant Z. However, the room camera acquires the room camera signal, which comprise information related to the participant Z, and the participants X, Y in the meeting room. The room camera metadata may comprise information about identification of the three participants X, Y and Z.

The method may comprise determining whether a participant participating the video communication with an individual device or not.

This can be determined directly based on the metadata of the room camera signal, e.g., the detection of a person without a laptop. The participant without an individual device may be identified based on the metadata of the room camera signal.

This can be determined indirectly based on the metadata of the room camera signal, e.g., the detection of three persons in the meeting room, and the information of the number of participants participating the video communication, e.g., the number of accounts logged in to the video communication.

The sensor signal X may comprise information about the participant X. The metadata X may comprise information about the participant X.

The sensor signal Y may comprise information about the participant Y. The metadata Y may comprise information about the participant Y.

The method may comprise upon determining a participant, e.g., the participant Z, participating the video communication without an individual device (e.g., not logging in with his own account), the client processing device requesting a part of the sensor signal, e.g., the room camera signal, comprising information related to said participant for generating the signal associated with the participant for video communication.

The lower part of FIG. 5d schematically shows two generated signals associated with the participant X and Y, respectively, for video communication, based on the received at least a part of the respective sensor signals.

The signal associated with the participant X/Y may be generated by the client processing device X/Y. The signal associated with the participant X/Y may be generated based on:
i) a part of the sensor signal X/Y, when the presence of the participant X/Y is detected in the sensor signal X/Y, respectively, e.g., the participant X/Y facing the laptop camera X/Y; and
ii) a part of the room camera signal, e.g., zoomed to focus on the identified participant Z in the meeting room, zoomed to focus on all the identified/detected participants in the meeting room, or a full view of the meeting room, if it is determined that a participant (e.g., the participant Z) participating the video communication without an individual device (e.g., not logging in with his own account).

Thus, the participant Z without an individual device may be included in the generated signal associated with other participants, e.g., the participant X/Y, by using a part of the room camera signal comprising the information of the participant Z.

The meaning of “at least a part of . . . ” throughout the present specification mostly refers to the portion of the signal which is relevant for the remaining steps of the method or for the other system elements. The complete sensor signal or video signal may be provided; however, a portion of the signal may not be useful or relevant for the remaining steps of the method or for other system elements, and the transfer of this remaining portion of the signal is thus not mandatory but is optional.

The means to transform the signals to be at least a part of the signals can depend on the metadata and the type of metadata, the implementation, the type of signal, etc. Such means may be rule-based, AI-driven, heuristics, etc.

For example, if people are detected in a video, an implementation might prefer to crop (transform) towards these people but keeping with a certain aspect ratio. If no people are detected, the whole stream may be sent. Or in another example, a whiteboard is being used that is in view of a camera, and the metadata and logic determines that there are no other interesting information to show so it is transformed by cropping. addition, the request might include parameters to control this transform, so in some implementations the host might send different signals to different clients.

The client, when sending the request to the host (based on the metadata), can optionally send transformation parameters which can additionally control the transformation of the signal to the “at least a part of the signal”. Such transformation parameters can be different for each client such that the host then adapts the signal to the client. In other words, the signal being sent from a host to one or more clients can be different or adapted to each client. In other examples, the signal can be the same for all clients.

The above may be examples of the strategy of generating the signal associated with the participant X and Y for video communication.

According to some further aspect, a method is provided for generating a signal associated with a participant of video communication. The method comprises providing at least a first sensor and a second sensor in a meeting location, each sensor acquiring a respective sensor signal, wherein at least one of the acquired sensor signals comprises information related to the participant; analyzing at least one of the first or second sensor signal for generating respective metadata, wherein the respective metadata comprises information about the respective sensor signal; generating the signal associated with the participant of video communication based on at least a part of the first sensor signal and on at least a part of the second sensor signal and the respective metadata.

A first sensor may be connected to or integrated in a video conference system in the meeting location. A second sensor may be connected to or integrated in a user processing device in the meeting location. Such user processing device may be brought by a participant of video communication into the meeting location.

The generated signal associated with the participant of video communication may be communicated to a unified communication system. A unified communication system can be used to communicate between participants from within the same meeting location and outside of the meeting location. By communicating the generated signal associated with the participant of video communication to the unified communication system, the participant of video communication can be better represented within the unified communication system as the signal may include information from multiple sensor signals. A unified communication session may be accessed by a user processing device, by a video conference system, or by any other device capable of accessing a unified communication session. Multiple accesses from within the same meeting location are possible. For example, multiple user processing devices in the same meeting location may access the unified communication session. A video conference system may access the unified communication session. A single device may have multiple accesses to the unified communication session. For example, a video conference system or another device may provide an access to the unified communication session for each of the participants in the meeting location or provide a subset of accesses for multiple entities within the communication session. For example, a video conference system or another device may provide an access to the unified communication system that represents the group of participants in the meeting location while one or more additional accesses are provided for a (sub)set of the participants in the meeting location. The subset may, for example consist out of a changing group of participants who are most active in the meeting location. The participant of video communication from the generated signal associated with the participant of video communication may thus change over time, representing a different participant in the unified communication system over time.

Alternatively, the generated signal associated with the participant of video communication that is communicated to the unified communication system may be dynamically switched to a different signal associated with another participant of video communication.

The generated signal associated with the participant of video communication may be communicated to a unified communication system by means of a user processing device, by means of a video conference equipment, or by any other means that enables communicating the generated signal associated with the participant of the video communication to a unified communication system.

The functional blocks of the system, such as the analysis of the sensor signals or the generation of the signal associated with the participant may be mapped to the physical devices without limitation. Functional blocks may be split over multiple physical devices and a single physical device may provide functionality of multiple functional blocks or parts of functional blocks.

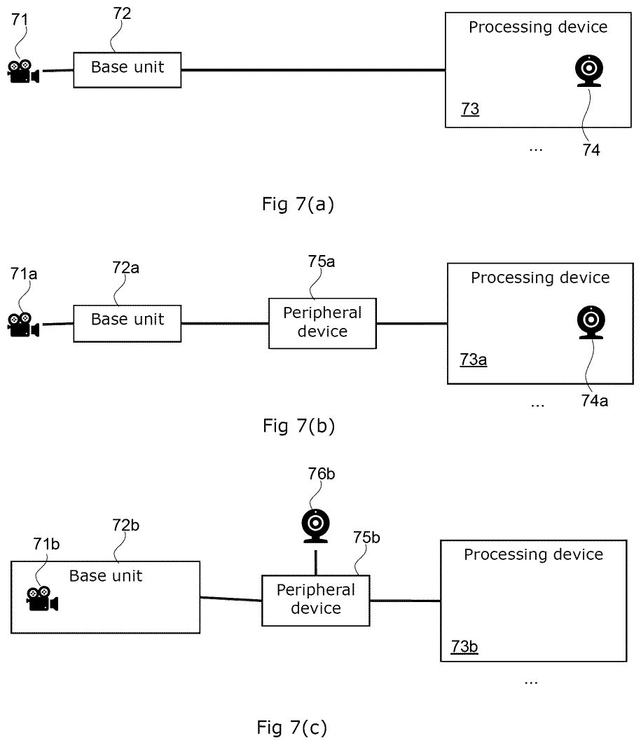

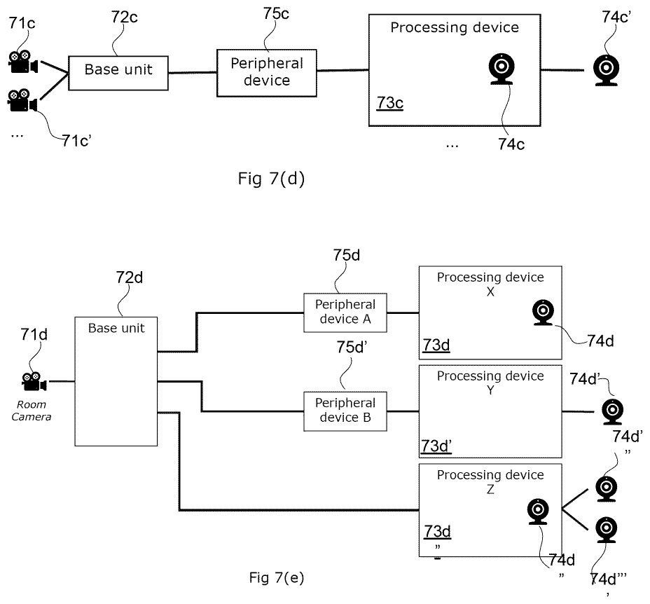

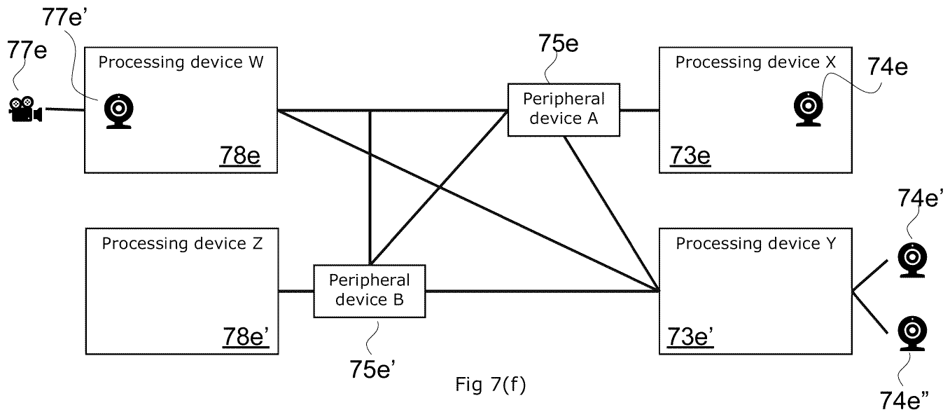

FIG. 7(a)-7(f) illustrate some examples of the physical devices that may be involved. It should be appreciated that the figures, the description of these figures and the features and aspects described within are interchangeable across the different scenarios within these figures, and across the scenarios not denoted in these figures. The aspects in the figures may furthermore be combined freely, without changing the principles that are described within. While these figures and the description illustrate some possible combinations of mapping functionality to devices, they should not be considered limiting and other combinations and variations are thus possible and probable. The host processing device(s) functionalities and client processing device(s) functionalities may be shared among the same devices or split across multiple devices. It should be appreciated that the mapping of these functionalities is implementation dependent and can be changed without affecting the basic principles of the invention.

FIG. 7(a) shows a base unit in a meeting location that is connected to a meeting location sensor 71. In addition, the sensor 71 may be connected to or integrated in the base unit 72. It is acknowledged that the terms “connected to” and “coupled to” are used interchangeably and are understood to convey a similar meaning, indicating a functional or physical association between components, devices, or elements within the invention. Said sensor 71 may, for example, be a room camera, a smart camera, a multi-camera device, a generative-AI camera, a virtual camera, a room microphone, an ultrasound sensor, an infrared sensor, a wearable sensor. The base unit 72 may be a separate physical unit or the base unit 72 may be part of another device that offers the functionalities of the base unit. For example, the base unit functionality may be built into an all-in-one device that provides A/V functionalities. For example, the base unit functionality may be part of a device capable of processing. The base unit 72 may be virtual having functionality provided by a cloud-enabled service or a distributed deployment. There may be more than one base unit.

A processing device 73 is shown that has a sensor 74 integrated in or connected to the device. Said sensor 74 may, for example, be a camera, a smart camera, a multi-camera device, a generative-AI camera, a virtual camera, a room microphone, an ultrasound sensor, an infrared sensor, a wearable sensor. The processing device 73 may be a user processing device, for example a laptop that is brought by the user into the meeting location. The user processing device may, for example, be a tablet or a phone or a wearable. The processing device 73 may be a general-purpose processing device. There may be more than one processing device.

The base unit 72 and the processing device 73 are connected via a means for communication. The means for communication may be direct. For example, the base unit 72 communicates directly with the processing device 73 via the communication medium. Or, the means for communication may be indirect. For example, the base unit 72 communicates with the processing device indirectly, with hops in between, for example via a cloud infrastructure. The means for communication may be wired or wireless. Typical means or communication are a WiFi connection, a Bluetooth connection, an ethernet connection, a USB connection, a serial connection, an optical connection.

There may be more than one processing device connected to the base unit. There may be more than one base unit to which the processing device is connected.

In some embodiment, the processing device 73 is a user processing device that generates the signal associated with the participant of video communication. The generated signal associated with the participant of video communication may be communicated to a unified communication session that is accessed by the processing device 73. Alternatively, the generated signal associated with the participant of video communication may be communicated to a unified communication session that is accessed by the base unit 72 where the generated signal associated with the participant of video communication is sent from the processing device 73 to the base unit 72. Alternatively, the generated signal associated with the participant of video communication may be communicated to a unified communication session that is accessed by a second processing device, where the generated signal associated with the participant of video communication is sent from the processing device 73 to the second processing device. The generated signal may be exposed to the processing device 73 by means of a virtual device, for example by means of a USB virtual device driver. By doing so, the processing device 73 may have a virtual USB camera exposed to the applications running on the processing device and this virtual USB camera may expose the generated signal associated with a participant of video communication to the processing device 73. By doing so, the processing device 73 does not require specific support for being able to use said generated signal but instead can rely on the operating system support for consuming the generated signal on the processing device 73. The sensor signal of the sensor 74 that is connected to or integrated in the user processing device may be analyzed. The analysis may be done by a processing device or by a base unit. The analysis may estimate whether the signal of the sensor 74 that is connected to or integrated in the user processing device 73 is a signal that represents the user optimally. In one variant, the viewing direction of the user with respect to the sensor 74 that is connected to or integrated in the user processing device 73 may be analyzed. In addition, it may be analyzed whether the user is speaking, or the meeting dynamics may be analyzed. Multiple analysis steps may be done to assess the representation capabilities of the sensor 74 that is connected to or integrated in the user processing device 73. The signal associated with the participant of video communication may be generated using this analysis. If the sensor 74 that is connected to or integrated in the user processing device 73 is estimated to be representative for the user, the signal associated with the participant of video communication may primarily include at least part of the signal from the sensor 74 that is connected to or integrated in the user processing device 73. If the sensor 74 that is connected to or integrated in the user processing device 73 is estimated not to be representative for the user, the signal associated with the participant of video communication may primarily include at least a part of the sensor signal from the sensor 71 that is connected to or integrated in the base unit 72. In some other embodiment, the signal from the sensor 71 that is connected to or integrated in the base unit 72 is always sent to the user processing device 73. In some further embodiments, at least a part of the sensor signal from the sensor 71 that is connected to or integrated in the base unit 72 is requested by the user processing device 73 when the analysis indicates that the sensor 74 that is connected to or integrated in the user processing device 73 is not representing the user sufficiently.

In another variant, the base unit 72 has a determination step that determines whether to send at least a part of the sensor signal from the sensor 71 that is connected to or integrated in the base unit 72 to a user processing device 73. The determination step may take into account a maximum number of signals to be sent, a maximum amount of resources that can be used, a maximum duration that a signal can be sent continuously, a metric based on expected user experience or any other factor that may influence the determination of the base unit 72 to send at least a part of the sensor signal from the sensor 71 that is connected to or integrated in the base unit 72 to a user processing device 73.

The determination step may include a selection mechanism that selects a subset of the user processing devices to where at least part of the sensor signal from the sensor 71 that is connected to or integrated in the base unit 72 is sent. The selection mechanism may use a priority mechanism that prioritizes the different user processing devices based on, for example, viewing direction of users in the meeting space, meeting dynamics in the meeting space, user behavior in the meeting space such as whether a user is talking, the history of earlier selections, metadata information. The selection mechanism may be based on round-robin principle, random selection mechanism, a weighted random sampling method, a first-in first-out (FIFO) method, a first-in last-out (FILO) method or any other method that provides subsets from a selection of implicitly or explicitly requesting client processing devices. A request for an at least part of a sensor signal may not directly be granted, but instead may be declined. Or, the request may only be granted after some time based on the determination step and/or the selection mechanism.

In some other embodiment, the base unit 72 generates the signal associated with the participant of video communication. The generated signal associated with the participant of video communication may be communicated to a unified communication session that is accessed by the base unit. Alternatively, the generated signal associated with the participant of video communication may be communicated to a unified communication session that is accessed by the processing device or another processing device, where the generated signal associated with the participant of video communication is sent from the base unit 72 to the processing device 73 or another processing device. Alternatively, the generated signal associated with the participant of video communication may be communicated to a unified communication session that is accessed by a second base unit, where the generated signal associated with the participant of video communication is sent from the base unit to the second base unit. The base unit 72 or the at least one processing device 73 may analyze the sensor signals from the sensors 71 attached to the base unit 72 and/or the sensor signals from the sensors 74 attached to the at least one processing device 73. The base unit 72 may generate more than one signal associated with the participant of video communication. For example, the base unit 72 may generate a signal associated with each of the participants of video communication in the meeting location and the base unit 72 may generate a signal associated with a set of participants of video communication in the meeting location. The base unit 72 may always receive at least a part of the sensor signal of the sensor 74 connected to or integrated in the processing device 73 or sensor signal of the sensor connected to or integrated in another base unit. The base unit 72 may request at least a part of the sensor signal of the sensor 74 connected to or integrated in the processing device 73 or sensor signal of the sensor connected to or integrated in another base unit when needed. At least a part of the sensor signal may then be sent after receiving the request. As mentioned before, aspects previously discussed such as the determination step and the selection mechanism are also applicable here for the sensors and sensor signals in each of the devices.

FIG. 7(b) shows a base unit 72a in a meeting location that is connected to a sensor 71a. Such a sensor 71a may, for example, be a room camera, a smart camera, a multi-camera device, a generative-AI camera or a virtual camera, a room microphone, an ultrasound sensor, an infrared sensor, a wearable sensor. The base unit 72a may be a separate physical unit. The base unit 72a may be part of another device that offers the functionalities of the base unit. For example, the base unit functionality may be built into an all-in-one device that provides A/V functionalities. For example, the base unit functionality may be part of a device capable of processing. The base unit functionality may be provided by a cloud-enabled service or a distributed deployment.

A processing device 73a is shown that has a sensor 74a integrated in or connected to the processing device 73a. Such a sensor 74a may, for example, be a camera, a smart camera, a multi-camera device, a generative-AI camera or a virtual camera, a room microphone, an ultrasound sensor, an infrared sensor, a wearable sensor. The processing device 73a may be a user processing device, for example a laptop that is brought by the user into the meeting location. The processing device 73a may, for example, be a tablet or a phone or a wearable. The processing device 73a may be a general purpose processing device.

A peripheral device 75a is shown that is connected to a processing device 73a. The peripheral device 75a may provide wired or wireless connectivity to the base unit. The peripheral device 75a interfaces with the processing device 73a in a wired or wireless manner. The peripheral device 75a may be a device that needs to be physically coupled to the processing device, for example via USB. The peripheral device 75a may be a separate device or be part of another device.

The base unit 72a and the peripheral device 75a are connected via a first means for communication. The peripheral device 75a and the processing device 73a are connected via a second means for communication. The processing device 73a and the base unit 72a may be connected via a third means for communication. The first, second and third means for communication may be the same means for communication, different means for communication or a combination thereof. The means for communication may be direct or indirect. The means for communication may be wired or wireless. Typical means or communication are a WiFi connection, a Bluetooth connection, an ethernet connection, a USB connection, a serial connection, an optical connection.

As mentioned before, the description of FIG. 7(a) is also relevant for FIG. 7(b).

The peripheral device may execute a number of the functions of the processing device as, for example, described in the description of FIG. 7(a). The peripheral device may execute a number of functions of the base unit as, for example, described in the description of FIG. 7(a). The use of an additional peripheral device 75a may have the advantage of having a dedicated communication channel between the peripheral device 75a and the base unit 72a. This communication channel may for example be used to exchange metadata, exchange at least a part of sensor signals and/or exchange the generated signals associated with the participant of video communication. The peripheral device 75a may analyze signal data of one of the sensors 74a in the system. The peripheral device 75a may analyze signal data of a sensor 74a that is coupled to or integrated in the processing device 73a to which the peripheral device 75a is connected to. The peripheral device 75a may generate the signal associated with a participant of video communication. The peripheral device 75a may expose a generated signal associated with a participant of video communication to said processing device 73a. The generated signal may be exposed to the processing device 73a through a (virtual) device that is exposed by the peripheral device 75a. This (virtual) device may be exposed to the processing device 73a in a transparent manner, meaning that the processing device 73a does not require explicit installation and/or running of software that is not part of the typical operating system of the processing device 73a to use said (virtual) device. For example, the (virtual) device may not require drivers to be installed and instead relies on drivers that are available on a typical operating system installation. In some embodiments, the peripheral device 75a is a USB device that is coupled to the processing device 73a. The peripheral device 75a coupled to a processing device 73a may expose a sensor 74a such as a USB camera device and the USB camera device may send the generated signal associated with a participant of video communication to said processing device 73a. By doing so, said processing device 73a does not require specific support to use said generated signal but instead one can rely on the operating system support for consuming the generated signal on the processing device 73a. By doing so, client software running on the operating system that provides access to a unified communication session may use the generated signal in a standard way, for example as if one would connect a physical camera to the processing device and use it in said unified communication session. Said processing device 73a may then ‘see’ a camera that exposes the data stream representing said generated signal associated with a participant of video communication, even if there is no physical camera that exposes said signal.

A generated signal associated with a participant of video communication that is based on at least part of the sensor signal of a sensor 74a coupled to or integrated in a processing device 73a may be exposed to said processing device 73a via a peripheral device 75a that is coupled to said processing device 73a. In that case, at least a part of the sensor signal of a sensor 74a coupled to or integrated in said processing device 73a may need to be communicated to said peripheral device 75a. Said communication may be using an existing or an additional data channel between said processing device 73a and said peripheral device 75a. In one variant where said peripheral device 75a is a USB device that is coupled to said processing device 73a. Said data channel may use an existing or additional USB endpoint on said peripheral device. Said data channel may use a Human Interface Device-or HID-endpoint on said peripheral device. Said data channel may use a network communication interface that is exposed through the peripheral device. Alternatively, said communication may be using a data channel between said processing device and another device in the system, said other device using an additional data channel between said other device and said peripheral device. The peripheral device 75a may generate the signal associated with a participant of video communication based on said on at least part of the sensor signal of a sensor 74a coupled to or integrated in said processing device 73a and at least part of a second sensor signal. At least a part of a second sensor signal may be sent from a base unit 72a. At least a part of a second sensor signal may be sent from a processing device 73a.

A generated signal associated with a participant of video communication that is based on at least part of the sensor signal of a sensor 74a coupled to or integrated in a processing device 73a may be exposed to said processing device 73a via a peripheral device 75a that is coupled to said processing device 73a. Said exposure may include a processing step on the processing device 73a that generates the signal associated with the participant of video communication based on at least a part of the sensor signal of a sensor 74a coupled to or integrated in a processing device 73a and at least a part of the sensor signal(s) that is communicated between said peripheral device 75a and said processing device 73a. For example, said processing step may receive at least part of the sensor signal of a sensor 74a coupled to or integrated in a processing device 73a and the processing step may furthermore receive at least part of a second sensor signal. The processing step may determine that, when receiving at least a part of a second sensor signal, that the exposed generated signal associated with a participant of video communication will primarily include said at least part of a second sensor signal and when not receiving at least a part of a second sensor signal, that the exposed generated signal associated with a participant of video communication will primarily include said at least part of the sensor signal of a sensor 74a coupled to or integrated in a processing device 73a. By doing so, said peripheral device 75a may expose the generated signal associated with a participant of video communication without the generation logic residing on the peripheral device 75a or with the generation logic only partially residing on the peripheral device 75a or another device. Instead, a processing step is placed in between the peripheral device 75a and the application that consumes the generated signal, said processing step generating the signal associated with a participant of video communication. Said processing step may be available to the processing device 73a without requiring administrative rights. Examples of said processing step technologies include Device MFT or DMFT in the Microsoft Windows operating system, enabling post-processing on connected devices in an application-agnostic manner. Installation of such post-processing capabilities and/or drivers may happen in user space, not requiring administrator privileges. Similar technologies are available for other operating systems.

As illustrated by the variant in FIG. 7(c), the peripheral device may provide a sensor 76b that is connected to or integrated in the peripheral device 75b. The sensor 76b may be, for example, a camera, a smart camera, a multi-camera device, a generative-AI camera, a virtual camera, a room microphone, an ultrasound sensor, an infrared sensor, a wearable sensor. The peripheral device 75b may expose a generated signal associated with participant of video communication to the processing device 73b without any need for specific software on the processing device 73b. The analysis of the various sensor signals may happen in the peripheral device 75b, in the base unit 72b, in the processing device 73b or in a combination thereof. The generation of the exposed signal may happen in the peripheral device 75b, in the base unit 72b, in the processing device 73b or in a combination thereof. The peripheral device 75b may provide a sensor 76b that is acquiring a respective sensor signal. A generated signal associated with the participant of video communication may be based on at least part of said respective sensor signal. The peripheral device 75b may analyze said respective sensor signal. The peripheral device 75b may analyze other sensor signals. At least a part of the said sensor signal of the sensor 76b on the peripheral device 75b may be used by a base unit 72b and/or a processing device 73b to analyze.

As illustrated in FIG. 7(d), multiple sensors can be connected to or integrated in the same device. For example, the base unit 72c may have multiple cameras 71c, 71c′ (physical or virtual) connected to or integrated in the device. For example, the processing device 73c may have multiple cameras 74c, 74c′ (physical or virtual) connected to or integrated in the device. As mentioned earlier, the functionalities to analyze, modify and expose the related sensor signals may be provided by the device to which the sensor is connected to or integrated in itself, by another device or distributed across multiple devices. FIG. 7(e) and 7(f) illustrate two possible combinations of the aforementioned aspects. These should be considered as mere examples and should not be seen as limiting. The processing device may use a peripheral device or it may not use a peripheral device and the examples shown in these figures should not be interpreted as limiting, including not limiting to the use of a peripheral device or not using a peripheral device. The use of a peripheral device is interchangeable with not using a peripheral device.

In an exemplary embodiment, each of the processing devices 73d, 73d′, 73d″ represent user processing devices and each of the user processing devices join the same unified communication session. Each of the user processing devices has access to a generated signal associated with the participant of video communication who is associated with the user processing device, and communicates the respective generated signal to the respectively accessed unified communication session. As such, the unified communication session has multiple representations from within the meeting room, for example, one for each of the user processing devices. These representations may have a different generated signal associated with the participant of video communication that is based on the different real-and/or virtual sensors that are available.

In an exemplary embodiment, mapping functionalities of a multi-processing device system, as the one depicted in FIG. 7(e), the base unit 72d only sends at least part of the sensor data of the sensor 71d that is connected to or integrated in the base unit 72d to a maximum number of user processing devices 73d, 73d′, or 73d″, for example, maximally to 1. The user processing devices 73d, 73d′, 73d″ and/or the coupled peripheral devices 75d, 75d′ analyze the respective sensor signal from the sensor 74d, 74d′, 74d″, 74d″′, 74 d″″ that is coupled to or integrated in the respective user processing device 73d, 73d′, 73d″ and indicate, via metadata, to the base unit 72d to what extend they need or can make use of at least a part of the signal(s) of the sensor(s) 71d that is coupled to or integrated in the base unit 72d. The base unit 72d determines and selects which of the user processing device 73d, 73d′, 73d″ to send at least a part of the signal(s) of the sensor(s) 71d that is coupled to or integrated in the base unit 72d at a given point in time. The base unit 72d can make use of the provided metadata from the user processing devices 73d, 73d′, 73d″, pre-defined rules that determine, for example, how long a user processing device can keep the signal and any other data that can be relevant to the determination and selection mechanism. When a user processing device 73d, 73d′, 73d″ analyzes that (one of) the sensor(s) 71d coupled to or integrated in the base unit 72d is useful, and the user processing device 73d, 73d′, 73d″ receives at least part of the sensor signal from the sensor 71d coupled to or integrated in the base unit 72d, the user processing device 73d, 73d′, 73d″ may use at least a part of the sensor signal to generate the signal associated with the respective participant of video communication. When no such sensor signal is sent to the user processing device 73d, 73d′, 73d″, the sensor signal of the sensor(s) 74d, 74d′, 74d″, 74d″, 74d″″ coupled to or integrated in said user processing device 73d, 73d′, 73d″ may be used to generate the signal associated with the respective participant of video communication. When yet further sensor signals are sent to the user processing device 73d, 73d′, 73d″, these sensor signals may be used to generate the signal associated with the respective participant of video communication.

In another example of mapping functionalities to a multi-processing device system as the one depicted in FIG. 7(e), the base unit 72d generates a signal associated with the participant of video communication. The participant of video communication is (a subset of) the meeting participants in the meeting location. For example, the generated signal from the base unit 72d may represent the participants in the meeting location that are not represented by another generated signal associated with the participant of video communication. For example, the generated signal by the base unit 72d may represent all participants in the meeting location. When analyzing one or multiple sensor signals in the meeting location, the generated signal associated with the (subset of) the meeting participants in the meeting location can represent the relevant participants in the optimal manner, adapting to the situation and conditions at hand. The generated signal may be communicated to the unified communication session by (any of) the base unit(s) or by (any of) the processing device(s).

FIG. 7(f) illustrates a case where there is no base unit involved. Instead, processing devices 78e, 78e′, 73e, 73e′ communicate among each other. The communication includes metadata, at least part of sensor signal(s) and generated signal(s) associated with the participant of video communication. In some cases, there may be no sensors that are provided by the meeting location. In some cases, there may be sensors provided by the meeting location. Sensors may be handled by devices that are not physically coupled to said sensors. Instead, the sensors may be, directly or indirectly, connected through a communications network. A device provided by the meeting location, for example a room camera, may be handled by one of the processing devices for including said sensor into the system that facilitates generation of the one or more signals associated with the respective participant(s) of the video communication. As shown, the communication paths across the devices can have any type of topology-for example centralized, distributed or anything in between.

Generating the signal associated with the participant of video communication may be functionally split and may be deployed across multiple devices. A component may be generating a part of the signal associated with the participant of video communication and another component may be generating another part of the signal associated with the participant of video communication. Yet another component may generate the signal associated with the participant of the video communication based on said at least one part of the signal associated with the participant of video communication. Said yet another component may generate the signal associated with the participant of the video communication additionally based on at least part of a sensor signal. The generated signal associated with the participant of video communication may thus be the result of a series of steps that each generate a part of said generated signal associated with the participant of video communication. Said series of steps may be sequentially executed, one after another. Said series of steps may be hierarchically executed, for example using a tree structure, where at least part of a sensor signal and/or at least part of a generated signal are combined and may result in the generated signal associated with the participant of video communication or may result in yet another at least part of the generated signal that can then be further combined. Said series of steps may be executed according to a graph structure.

The strategy of generating the signal associated with the participant for video communication shown in the figures and discussed in the examples for illustrating the inventive concept of the invention are purely exemplary and should not be seen as limiting the invention in any means.

The person skilled in the art realizes that the present invention by no means is limited to the examples described above. On the contrary, many modifications and variations are possible within the scope of the appended claims. For example, the sensor may comprise a processing circuit for providing the function of the host processing device. Such details are not considered to be an important part of the invention, which relates to the method of generating a signal associated with a participant of video communication.

The following are non-limiting enumerated example embodiments of the disclosed invention.

### Additional Clauses

1. A method of generating a signal associated with a participant of video communication, comprising:
   providing at least two sensors (1a, 1b, 1c) in a meeting location, each sensor acquiring a respective sensor signal, wherein at least one of the acquired sensor signals comprises information related to the participant;
   providing a host processing device (2a, 2b, 2c) for each of the at least two sensors for receiving and analysing the respective sensor signal for generating respective metadata, wherein the respective metadata comprises information about the respective sensor signal;
   each host processing device (2a, 2b, 2c) sending the respective metadata to a client processing device (3a, 3b, 3c);
   the client processing device (3a, 3b, 3c) determining, based on the received respective metadata, whether to request at least a part of the respective sensor signal acquired by at least one of the at least two sensors;
   upon determining to request the at least a part of the respective sensor signal, the client processing device (3a, 3b, 3c) sending a request to the host processing device receiving the respective sensor signal from the at least one of the at least two sensors;
   upon receiving the request, said host processing device (2a, 2b, 2c) sending the at least a part of the respective sensor signal to the client processing device;
   the client processing device (3a, 3b, 3c) generating the signal associated with the participant for video communication based on the received at least a part of the respective sensor signal.
2. The method of clause 1, wherein the participant of video communication is a person or a non-human object involving in the video communication.
3. The method of clause 1 or 2, wherein the signal associated with the participant for video communication is playable by a device involving in the video communication.
4. The method of any of clauses 1-3, further comprising:
   the client processing device (3a, 3b, 3c) sending the generated signal associated with the participant to a video communication device (5) for conducting video communication with a remote participant of video communication.
5. The method of any of clauses 1-4, wherein the step of the client processing device (3a, 3b, 3c) determining, based on the received respective metadata, whether to request at least a part of the respective sensor signal acquired by at least one of the at least two sensors (1a, 1b, 1c) comprises:
   the client processing device (3a, 3b, 3c) determining based on the received respective metadata and a strategy of generating the signal associated with the participant for video communication.
6. The method of clause 5, wherein the strategy is predetermined.
7. The method of clause 5 or 6, wherein the strategy is created and/or changed.
8. The method of any of clauses 1-7, wherein the step of the client processing device (3a, 3b, 3c) generating the signal associated with the participant for video communication comprises:
   the client processing device (3a, 3b, 3c) generating said signal based on the received at least a part of the respective sensor signal acquired by more than one sensor; and/or
   the client processing device (3a, 3b, 3c) generating said signal based on the received at least a part of the respective sensor signal acquired by each of the at least two sensors.
9. The method of any of clauses 1-8, wherein the step of the client processing device (3a, 3b, 3c) generating the signal associated with the participant for video communication based on the received at least a part of the respective sensor signal comprises:
   the client processing device (3a, 3b, 3c) generating the signal by any of: temporal multiplexing, spatial multiplexing, and multi-modal aggregation.
10. The method of any of clauses 1-9, wherein the step of each host processing device (2a, 2b, 2c) sending the respective metadata to a client processing device (3a, 3b, 3c) comprises:
   sending the respective metadata by using a centralised node (4) for receiving the respective metadata from the host processing device (2a, 2b, 2c), and forwarding to the client processing device (3a, 3b, 3c); and/or
   sending the respective metadata by a wireless connection or a wired connection between each host processing device (2a, 2b, 2c) and the client processing device (3a, 3b, 3c); and/or
   sending the respective metadata by using a metadata exchange service.
11. The method of clause 10, wherein the step of sending the respective metadata by a wireless connection or a wired connection comprises:
   sending the respective metadata by a broadcasting network; or
   sending the respective metadata by a point-to-point network.
12. The method of clause 10 or 11, wherein the step of sending the respective metadata by using a metadata exchange service comprises:
   the metadata exchange service receiving the respective metadata from each host processing device (2a, 2b, 2c), and forwarding to the client processing device (3a, 3b, 3c).
13. The method of clause 12, comprising:
   the metadata exchange service storing the respective metadata; and/or
   the metadata exchange service storing and/or updating a state of the respective metadata; and/or
   the metadata exchange service filtering the respective metadata.
14. The method of any of clauses 1-13, wherein the step of said host processing device (2a, 2b, 2c) sending the at least a part of the respective sensor signal to the client processing device (3a, 3b, 3c) comprises:
   sending said at least a part of the respective sensor signal by using a centralised node (4) for receiving said at least a part of the respective video signal from said host processing device (2a, 2b, 2c), and forwarding to the client processing device (3a, 3b, 3c); and/or
   sending said at least a part of the respective sensor signal by a wireless connection or a wired connection between said host processing device (2a, 2b, 2c) and the client processing device (3a, 3b, 3c).
15. The method of clause 14, wherein the step of sending said at least a part of the respective sensor signal by a wireless connection or a wired connection comprises:
   sending said at least a part of the respective sensor signal by a broadcasting network; or
   sending said at least a part of the respective sensor signal by a point-to-point network.
16. The method of any of clauses 1-15, wherein the step of providing a host processing device (2a, 2b, 2c) for each of the at least two sensors (1a, 1b, 1c) comprises:
   providing one host processing device (2a, 2b, 2c) for each of the at least two sensors (1a, 1b, 1c) such that each of the at least two sensors (1a, 1b, 1c) has an individual host processing device.
17. The method of any of clauses 1-15, wherein the step of providing a host processing device (2a, 2b, 2c) for each of the at least two sensors (1a, 1b, 1c) comprises:
   providing at least one host processing device (2a, 2b, 2c) for the at least two sensors (1a, 1b, 1c), such that at least one sensor of the at least two sensors shares a same host processing device with another sensor of the at least two sensors.
18. The method of any of clauses 1-17, wherein the host processing device (2a, 2b, 2c) comprises:
   a router function module (21) for receiving the respective sensor signal, receiving
   the request from the client processing device (3a, 3b, 3c), and sending the at least a part of
   the respective sensor signal to the client processing device (3a, 3b, 3c) upon receiving the request;
   an analysis function module (22) for analysing the respective sensor signal for generating the respective metadata; and
   a metadata router function module (23) for sending the generated metadata to the client processing device (3a, 3b, 3c).
19. The method of any of clauses 1-18, wherein the client processing device (3a, 3b, 3c) comprises:
   a metadata receiver function module (31) for receiving metadata from the host processing device (2a, 2b, 2c);
   a determination function module (32) for determining, based on the received respective metadata, whether to request at least a part of the respective sensor signal;
   a transceiver function module (33) for sending the request to the host processing device (2a, 2b, 2c), and receiving the at least a part of the respective video signal from the host processing device (2a, 2b, 2c); and
   a composing function module (34) for generating the signal associated with the participant for video communication.
20. The method of any of clauses 1-19, wherein the client processing device (3a, 3b, 3c) comprises a device body, and wherein at least one of the at least two sensors (1a, 1b, 1c) is attached to the device body; and/or
   wherein the host processing device (2a, 2b, 2c) comprises a device body, and wherein at least one of the at least two sensors (1a, 1b, 1c) is attached to the device body.
21. The method of any of clauses 1-20, wherein the signal associated with the participant of video communication is a video signal.
22. A system of generating a signal associated with a participant of video communication, comprising:
   at least two sensors (1a, 1b, 1c) provided in a meeting location, each sensor being configured to acquire a respective sensor signal, wherein at least one of the acquired sensor signals comprises information related to the participant;
   a host processing device (2a, 2b, 2c) provided for each of the at least two sensors, wherein each host processing device is configured to receive and analyse the respective sensor signal for generating respective metadata comprising information about the respective sensor signal,
   wherein each host processing device (2a, 2b, 2c) is configured to send the respective metadata to a client processing device (3a, 3b, 3c); and
   the client processing device (3a, 3b, 3c) configured to:
      determine, based on the received respective metadata, whether to request at least a part of the respective sensor signal acquired by at least one of the at least two sensors,
      upon determining to request the at least a part of the respective sensor signal, send a request to the host processing device (2a, 2b, 2c) receiving the respective sensor signal from the at least one of the at least two sensors;
   wherein said host processing device is configured to, upon receiving the request, send the at least a part of the respective sensor signal to the client processing device (3a, 3b, 3c);
   wherein the client processing device (3a, 3b, 3c) is configured to generate the signal associated with the participant for video communication based on the received at least a part of the respective sensor signal.
23. The system of clause 22, wherein the participant of video communication is a person or a non-human object involving in the video communication.
24. The system of clause 22 or 23, wherein the signal associated with the participant for video communication is playable by a device involving in the video communication.
25. The system of any of clauses 22-24, wherein the client processing device (3a, 3b, 3c) is configured to send the generated signal associated with the participant to a video communication device (5) for conducting video communication with a remote participant of video communication.
26. The system of any of clauses 22-25, wherein the client processing device (3a, 3b, 3c) is configured to determine, based on the received respective metadata and a strategy of generating the signal associated with the participant for video communication, whether to request at least a part of the respective sensor signal acquired by at least one of the at least two sensors.
27. The system of clause 26, wherein the strategy is predetermined.
28. The system of clause 26 or 27, wherein the strategy is created and/or changed.
29. The system of any of clauses 22-28,
   wherein the client processing device (3a, 3b, 3c) is configured to generate said signal based on the received at least a part of the respective sensor signal acquired by more than one sensor; and/or
   wherein the client processing device (3a, 3b, 3c) is configured to generate said signal based on the received at least a part of the respective sensor signal acquired by each of the at least two sensors.
30. The system of any of clauses 22-29, wherein the client processing device (3a, 3b, 3c) is configured to generate the signal by any of: temporal multiplexing, spatial multiplexing, and multi-modal aggregation.
31. The system of any of clauses 22-30,
   wherein the host processing device (2a, 2b, 2c) is configured to send the respective metadata by using a centralised node (4) for receiving the respective metadata from the host processing device (2a, 2b, 2c), and forwarding to the client processing device (3a, 3b, 3c); and/or
   wherein the host processing device (2a, 2b, 2c) is configured to send the respective metadata by a wireless connection or a wired connection between each host processing device (2a, 2b, 2c) and the client processing device (3a, 3b, 3c); and/or
   wherein the host processing device (2a, 2b, 2c) is configured to send the respective metadata by using a metadata exchange service.
32. The system of clause 31,
   wherein the host processing device (2a, 2b, 2c) is configured to send the respective metadata by a broadcasting network; or
   wherein the host processing device (2a, 2b, 2c) is configured to send the respective metadata by a point-to-point network.
33. The system of clause 31 or 32, wherein the metadata exchange service is configured to receive the respective metadata from each host processing device (2a, 2b, 2c), and forward to the client processing device (3a, 3b, 3c).
34. The system of clause 33,
   wherein the metadata exchange service is configured to store the respective metadata; and/or
   wherein the metadata exchange service is configured to store and/or update a state of the respective metadata; and/or
   wherein the metadata exchange service is configured to filter the respective metadata.
35. The system of any of clauses 22-34,
   wherein said host processing device (2a, 2b, 2c) is configured to send said at least a part of the respective sensor signal by using a centralised node (4) for receiving said at least a part of the respective video signal from said host processing device (2a, 2b, 2c), and forwarding to the client processing device (3a, 3b, 3c); and/or
   wherein said host processing device (2a, 2b, 2c) is configured to send said at least a part of the respective sensor signal by a wireless connection or a wired connection between said host processing device (2a, 2b, 2c) and the client processing device (3a, 3b, 3c).
36. The system of clause 35,
   wherein said host processing device (2a, 2b, 2c) is configured to send said at least a part of the respective sensor signal by a broadcasting network; or
   wherein said host processing device (2a, 2b, 2c) is configured to send said at least a part of the respective sensor signal by a point-to-point network.
37. The system of any of clauses 22-36, wherein one host processing device (2a, 2b, 2c) is provided for each of the at least two sensors (1a, 1b, 1c) such that each of the at least two sensors (1a, 1b, 1c) has an individual host processing device.
38. The system of any of clauses 22-36, wherein at least one host processing device (2a, 2b, 2c) is provided for the at least two sensors (1a, 1b, 1c), such that at least one sensor of the at least two sensors shares a same host processing device with another sensor of the at least two sensors.
39. The system of any of clauses 22-38, wherein the host processing device (2a, 2b, 2c) comprises:
   a router function module (21), configured to receive the respective sensor signal, receive the request from the client processing device (3a, 3b, 3c), and send the at least a part of the respective sensor signal to the client processing device (3a, 3b, 3c) upon receiving the request;
   an analysis function module (22), configured to analyse the respective sensor signal for generating the respective metadata; and
   a metadata router function module (23), configured to send the generated metadata to the client processing device (3a, 3b, 3c).
40. The system of any of clauses 22-39, wherein the client processing device (3a, 3b, 3c) comprises:
   a metadata receiver function module (31), configured to receive metadata from the host processing device (2a, 2b, 2c);
   a determination function module (32), configured to determine, based on the received respective metadata, whether to request at least a part of the respective sensor signal;
   a transceiver function module (33), configured to send the request to the host processing device (2a, 2b, 2c), and receive the at least a part of the respective video signal from the host processing device (2a, 2b, 2c); and
   a composing function module (34), configured to generate the signal associated with the participant for video communication.
41. The system of any of clauses 22-40, wherein the client processing device (3a, 3b, 3c) comprises a device body, and wherein at least one of the at least two sensors (1a, 1b, 1c) is attached to the device body; and/or
   wherein the host processing device (2a, 2b, 2c) comprises a device body, and wherein at least one of the at least two sensors (1a, 1b, 1c) is attached to the device body.
42. The system of any of clauses 22-41, wherein the signal associated with the participant of video communication is a video signal.

1-55. (canceled)

56. A method of generating a signal corresponding to a participant of a video communication, comprising:
providing a first sensor and a second sensor in a meeting location, the first sensor and the second sensor respectively generating a sensor signal, wherein at least one of the sensor signals comprises information related to the participant;
receiving and analyzing, by a first host processing device and a second host processing device, the sensor signals correspondingly from the first sensor and the second sensor for generating metadata, wherein the metadata comprises information corresponding to at least one of the sensor signals;
sending, by the host processing devices, the metadata to a client processing device;
generating, by the client processing device, the signal corresponding to the participant of video communication based on the received at least part of the at least one sensor signal.

57. The method of claim 56, wherein the first sensor is a video camera device that is connected to or integrated in a video conference system in the meeting location and wherein the second sensor is a video camera device that is connected to or integrated in a user processing device in the meeting location.

58. The method of claim 56, wherein the sensor signal is generated using the second sensor is analyzed by the user processing device for generating the metadata.

59. The method of claim 56, wherein the signal corresponding to the participant of the video communication that is generated by the user processing device is made available to a video communication client that is running on the user processing device, or
wherein the signal corresponding to the participant of the video communication is generated according to at least part of the sensor signal corresponding to the second sensor when the metadata indicates that the user of the user processing device is looking in the direction of the second sensor, and wherein the signal corresponding to the participant of the video communication is generated according to another sensor when the metadata indicates that the user of the user processing device is not looking in the direction of the second sensor.

60. The method of claim 56, wherein a peripheral device coupled to the user processing device provides the signal associated with the participant of the video communication to the user processing device.

61. The method of claim 56, wherein the metadata comprises information on the viewing direction of at least one user in the meeting location, or wherein the metadata corresponding to the second sensor comprises information on the viewing direction of a user of the user processing device relative to the second sensor.

62. The method of claim 56, further comprising:
determining, by the client processing device, to request at least a part of the sensor signal generated using at least one of the sensors according to the metadata;
sending, by the client processing device, a request to the host processing device receiving the sensor signal from the at least one of the two sensors.

63. The method of claim 56, further comprising:
when the metadata indicates that the user is looking towards the second sensor, requesting at least a part of the sensor signal corresponding to the second sensor according to the information of the viewing direction of the user of the user processing device corresponding to the second sensor, or
when the metadata indicates that the user is looking away from said second sensor, requesting at least a part of the sensor signal corresponding to the first sensor according to the information of the viewing direction of the user of the user processing device relative to the second sensor.

64. The method of claim 56, wherein the metadata comprises information on a voice activity of a user in said meeting location.

65. The method of claim 56, wherein generating the signal associated with the participant of video communication comprises:
determining of relevance of a sensor signal relative to another sensor signal;
determining of composition based at least on the relevance of a sensor signal relative to another sensor signal;
generating of the signal associated with the participant of video communication based on the determined composition.

66. The method of claim 65, wherein a composition temporally switches between at least a part of the sensor signal corresponding to the first sensor and at least a part of the sensor signal corresponding to the second sensor according to the determined relevance of each of the signals, or
wherein a composition applies a transform to at least a part of the sensor signal corresponding to the first sensor and at least a part of the sensor signal corresponding to the second sensor according to the determined relevance of each of the sensor signals and spatially or temporally combines the respective transformed signals.

67. A method of generating a signal corresponding to a participant of a video communication, comprising:
providing at least a first sensor and a second sensor in a meeting location, the first sensor and the second sensor respectively generating a sensor signal, wherein at least one of the sensor signals comprises information related to the participant;
analyzing at least one of the sensor signals to generate metadata, wherein the metadata comprises information corresponding to the sensor signal;
generating the signal corresponding to the participant of the video communication according to at least a part of the sensor signal corresponding to the first sensor and on at least a part of the sensor signal corresponding to the second sensor and the metadata.

68. The method of claim 67, wherein the first sensor is connected to or integrated in a video conference system and the second sensor is connected to or integrated in a user processing device.

69. The method of claim 67, wherein the metadata comprises information on the viewing direction of a user in the meeting location, or wherein the metadata comprises information on the voice activity of a user of the user processing device.

70. The method of claim 67, further comprising:
providing a first host processing device and a second host processing device respectively to the first sensor and the second sensor for receiving and analyzing the sensor signals, and generating metadata, wherein the metadata comprises information corresponding to at least one of the sensor signals;
sending, by each of the host processing devices, the metadata to a client processing device;
generating, by the client processing device, the signal corresponding to the participant of video communication according to at least a part of the sensor signal.

71. The method of claim 70, wherein at least a part of the sensor signal corresponding to at least one of the two sensors is requested by the client processing device determined according to the metadata;
the client processing device is configured to send a request to the host processing device receiving the respective sensor signal from the at least one of the two sensors;
the host processing device configured to send the at least a part of the sensor signal to the client processing device.

72. The method of claim 70, wherein the client processing device determines, based on the received respective metadata, whether to request at least a part of the respective sensor signal acquired by at least one of the two sensors;
upon determining to request the at least a part of the respective sensor signal, the client processing device sending a request to the host processing device receiving the respective sensor signal from the at least one of the two sensors;
upon receiving the request, said host processing device determining to send the at least a part of the respective sensor signal to the client processing device;
upon determination sending at least a part of the respective sensor signal to the client processing device.

73. The method of claim 72, wherein the host processing device is configured to send the at least a part of the sensor signal to the client processing device according to a priority for sending the at least a part of the sensor signal between client processing devices, or
wherein the host processing device sends the at least part of the sensor signal to a subset of client processing devices according to a priority, or
wherein the host processing device determines priority according to the metadata from the host processing device, or
wherein the host processing device determines priority for sending the at least a part of the sensor signal to the client processing device according to predetermined rules, or
wherein the host processing device determines priority for sending the at least a part of the sensor signal according to a maximum duration for receiving the at least a part of the sensor signal by a client processing device, or
wherein the host processing device determines priority for sending the at least a part of the sensor signal using at least one of a round-robin principle, a random selection, and a weighted random sampling method.

74. The method of claim 70, wherein a host processing device for a respective sensor controls the respective sensor by:
determining the control operations to be sent to the respective sensor to optimize the sensor signal;
sending control operations to the respective sensor;
the host processing device receiving an optimized sensor signal from the respective sensor.

75. A system of generating a signal corresponding to a participant of a video communication, comprising:
a first sensor and a second sensor configured to be provided in a meeting location, the first sensor and the second sensor respectively configured to generate a sensor signal, wherein at least one of the sensor signals comprises information related to the participant;
a first host processing device and a second host processing device configured to receive and analyze the sensor signals correspondingly from the first sensor and the second sensor, configured for generating metadata, wherein the metadata comprises information corresponding to at least one of the sensor signals;
wherein the host processing devices is configured to send the metadata to a client processing device;
and wherein the client processing device is configured to generate the signal corresponding to the participant of video communication based on the received at least part of the at least one sensor signal.
